(19) United States
(12) Patent Application Publication
(10) Pub. No.: US 2013/0183536 A1
(43) Pub. Date: Jul. 18, 2013

(54) RESIN COMPOSITION AND MOLDED PRODUCT THEREOF

(71) Applicant: Kaneka Corporation, Osaka (JP)

(72) Inventors: Yutaka KANEDA, Settsu-shi (JP); Tetsuo MEKATA, Osaka-shi (JP); Taizo AOYAMA, Settsu-shi (JP)

(73) Assignee: KANEKA CORPORATION, Osaka (JP)

(21) Appl. No.: 13/689,268

(22) Filed: Nov. 29, 2012

Related U.S. Application Data
(63) Continuation-in-part of application No. 13/350,148, filed on Jan. 13, 2012.
Application No. 13/350,148 is a continuation-in-part of application No. PCT/JP2011/062587, filed on Jun. 1, 2011.

(30) Foreign Application Priority Data
Jun. 1, 2010 (JP) 2010-126157
Jun. 1, 2010 (JP) 2010-126158
Jun. 1, 2010 (JP) 2010-126159

(51) Int. Cl. C08K 3/04; B32B 27/08; C08K 5/09; C08L 51/00; C08K 5/49; C08K 5/20

(52) U.S. Cl. CPC C08K 3/04; C08K 5/49; C08K 5/20; C08K 5/09; C08L 51/006; B32B 27/08
USPC 428/515; 524/115; 524/210; 524/300; 524/496

(57) ABSTRACT

The present invention aims to provide a molded product excellent in jet-blackness, weather resistance, mold-processability, boss strength, abrasion resistance and opaqueness, and a resin composition to provide the molded product.

The present invention relates to a resin composition comprising: an acrylic resin (A); and a carbon black (B) having a number average particle diameter of 10 to 40 nm.

### CROSS-REFERENCE TO RELATED APPLICATIONS

The present application is a continuation-in-part of Patent Cooperation Treaty (PCT) Application No. PCT/JP2011/062587, filed Jan. 1, 2011, and U.S. patent application Ser. No. 13/350,148, filed Jan. 13, 2012, the contents of which are incorporated herein by reference in their entirety.

### TECHNICAL FIELD

The present invention relates to a resin composition containing an acrylic resin and a carbon black having a number average particle diameter of 10 to 40 nm, and a molded product of the resin composition. Specifically, the present invention relates to a resin composition excellent in weather resistance, impact resistance, appearance, mold-processability, jet-blackness and the like, and a molded product prepared from the resin composition.

### BACKGROUND ART

Acrylic resin mainly containing polymethyl methacrylate is excellent in weather resistance, gloss, and transparency, but there is no resin which can simultaneously satisfy weather resistance, impact resistance, and jet-blackness. Thus, acrylic resin has limited uses.

In order to impart impact resistance to such methacrylic resin while maintaining the excellent weather resistance of the resin, methods of mixing various multilayer graft copolymers are proposed. Typical methods (a), (b), and (c) are summarized below.

The below-mentioned weather resistance, gloss, impact resistance, and processability are characteristics of methacrylic resin alone or a methacrylic resin composition obtainable by mixing a graft copolymer into methacrylic resin.

(a) In order to impart impact resistance to methacrylic resin while maintaining its excellent weather resistance, there has been proposed a method including: mixing into a methacrylic resin a graft copolymer having a rubbery polymer/hard polymer bilayer structure, which is obtained by polymerizing a monomer component such as alkyl methacrylate which can be a constitutional unit of a relatively hard polymer with a glass transition temperature of not lower than room temperature (hereinafter, referred to as a hard monomer component) with a rubbery polymer which mainly contains an alkyl acrylate having excellent weather resistance and which has a glass transition temperature of not higher than room temperature (Patent Documents 1 and 2).

(b) There has also been proposed a method including: forming a rubbery polymer layer mainly containing an alkyl acrylate on the surface of a hard polymer shell containing 70 to 100% (% by weight, the same applies to the following) of a hard monomer component (e.g. alkyl methacrylate); graft-polymerizing a hard monomer component (e.g. alkyl methacrylate) to the surface of the rubbery polymer layer to prepare a graft copolymer having a hard polymer/rubbery polymer/hard polymer three-layer structure; and mixing the graft copolymer into methacrylic resin (Patent Document 3).

(c) There has also been proposed a method including: copolymerizing 35 to 45% of an alkyl acrylate with the hard monomer component (e.g. alkyl methacrylate), which is the innermost layer in the method (b), with a crosslinkable monomer having at least two functional groups selected from the group consisting of acryloyloxy groups and methacryloyloxy groups in one molecule thereof to form a semi-rubbery polymer whose glass transition temperature is made to be close to room temperature; forming a rubbery polymer layer mainly containing an alkyl acrylate on the surface of the semi-rubbery polymer shell; graft-polymerizing a hard monomer component (e.g. alkyl methacrylate) to the surface of the obtained shell to prepare a graft copolymer having a three-layer structure of semi-rubbery polymer/rubbery polymer/hard polymer; and mixing the graft copolymer into methacrylic resin (Patent Document 4).

Further, a jet-black composition is disclosed which contains a thermosetting acrylic resin and a 1:2 chromium complex of a mono-azo dye substituted with amino-phenol and coupled with 2-naphthol (Patent Document 5). However, the dye has a problem of light resistance.

As a method for providing jet-blackness, Patent Literature 6 discloses a use of an acrylic resin laminated film. The acrylic resin laminated film includes a laminate of an acrylic resin layer (A) and an acrylic resin layer (B), has favorable matte appearance and jet-blackness and is excellent in printability, surface hardness, whitening resistance in molding, and trimming processability in molding. The acrylic resin layer (A) of the film has an arithmetic mean roughness of at least 0.01 μm and less than 0.1 μm on the opposite side of the acrylic resin layer (B)-formed side. The acrylic resin layer (B) of the film has a 60° surface glossiness of less than 60% on the opposite side of the acrylic resin layer (A)-formed side. The acrylic resin composition included in the acrylic resin layer (A) has a rubber content of at least 25% by mass and less than 40% by mass and a gel content of at least 45% by mass and less than 70% by mass. Patent Literature 6 also discloses a production method of the acrylic resin laminated film, and a laminate including the film, and also discloses use of the laminate as an automobile pillar component. However, the film disclosed in Patent Literature 6 is expensive due to process for producing a pillar part with jet-black appearance, such as lamination of a film on a structure resin. In addition, the film has a problem of damage in tapping for opening screw holes.

Methods for making materials themselves jet-black include use of a heat-ray shielding plate produced from a methacrylic resin containing an infrared absorber and a carbon black (Patent Literature 7) and use of a heat-ray shielding methacrylic resin composition produced from a methacrylic resin containing a specific carbon black (Patent Literature 8). Also known as the method is production of a black and transparent (smoke) film containing a dye as a skin material of an olefin-resin molding base material (Patent Literature 9). In Patent Literatures 7 and 8, however, the particle size of the carbon black used is so large that the appearance of an obtained molded product is spoiled. Additionally, in the shielding plate of Patent Literature 7, the infrared absorber has a problem in light resistance. In Patent Literature 9, since the dye used has a small particle size, the weather resistance of the dye is significantly low. This problematically results in low weather resistance of the film.

As a method for enhancing the impact resistance, Patent Literature 10 discloses a transparent plastic molded product. The molded product has: an acrylic resin layer obtained from a hydroxy group-containing acrylic copolymer resin laminated as a first layer on at least one face of a transparent plastic substrate such as an acrylic resin substrate, and a thermosetting coating film layer of an organosiloxane resin composition laminated thereon. The acrylic resin layer is formed by thermosetting a coating composition containing, a hydroxy group-containing acrylic copolymer resin, a polyisocyanate compound and/or a polyisocyanate compound precursor with an isocyanate group content of 5.0 to 60% by weight (in an amount that the total isocyanate group is 0.7 to 5 equivalents for one equivalent hydroxy group in the hydroxy group-containing acrylic copolymer resin), and an ultraviolet absorber in an amount of 10 to 50 parts by weight for 100 parts by weight of coating resin. The thermosetting coating film layer of an organosiloxane resin composition includes a colloidal silica and a hydrolysis condensate of trialkoxysilane. The molded product disclosed in Patent Literature 10 actually has significantly enhanced durability and excellent abrasion resistance and hot water resistance. However, problematically, the number of steps for producing the abrasion-resistant plastic molded product is large and the product is expensive.

In order to impart impact resistance while keeping the excellent weather resistance of an acrylic resin, a method of mixing various multilayer graft copolymers is proposed. Though the impact resistance is enhanced in this method, blending of different materials causes a white turbidity of the resin. As a result, properties such as transparency and jet-blackness may be significantly deteriorated or flowability of the resin may be lowered.
Patent Document 1: U.S. Pat. No. 3,808,180
Patent Document 2: U.S. Pat. No. 3,843,753
Patent Document 3: U.S. Pat. No. 3,793,402
Patent Document 4: Japanese Patent Application Publication S62-230841
Patent Document 5: Japanese Patent Application Second Publication H6-089279
Patent Document 1: JP-A 2009-255555
Patent Document 2: JP-A H07-173358
Patent Document 3: JP-A H07-62189
Patent Document 4: JP-A 2006-224459
Patent Document 5: JP-A 2003-342403

The disclosure of the respective related art documents is incorporated herein by reference.

### SUMMARY OF INVENTION

### Technical Problem

The present invention aims to provide an acrylic resin composition excellent in weather resistance, gloss, jet-blackness, impact resistance, and processability, and a molded product prepared from the resin composition.

The present invention also aims to provide simply and at a low cost a resin composition for producing a molded product excellent in weather resistance, gloss, uniform blackness (i.e. black-color appearance) even in the case of a large injection-molded part, impact resistance, and boss strength.

The present invention especially aims to provide a resin composition for producing a molded product excellent in all of weather resistance, abrasion resistance, and jet-blackness.

The present invention further aims to provide a resin composition for producing a molded product having excellent black appearance and opaqueness which is usable as an automobile component.

### Solution to Problem

The present inventors have intensively studied to solve the above problem to find out that a thermoplastic resin containing a carbon black having a number average particle diameter in a predetermined range provides a resin composition excellent not only in blackness and weather resistance but also in mold-processability, boss strength, abrasion resistance, and opaqueness, and thereby completed the present invention.

The present inventors have found that it is difficult to obtain an acrylic resin excellent in jet-blackness and weather resistance by blending a dye such as an azo compound in order to achieve jet-blackness, as mentioned in Patent Document 5, because the weather resistance of the dye itself and the weather resistance of a base resin affected by the dye are reduced. In order to solve the above problem, the present inventors have found carbon black as a jet-black material which less affects its own light resistance and the base resin, and have performed studies on a method for achieving excellent jet-blackness in the combination of the carbon black and an acrylic resin. As a result, the inventors have found that the problem can be solved by blending carbon black in a transparent rubber modified acrylic resin and dispersing the carbon black into a resin composition such that the particle diameter of the carbon black is 10 to 40 nm. Finally, the inventors have completed the present invention.

The present invention relates to a resin composition comprising:

an acrylic resin (A); and

a carbon black (B) having a number average particle diameter of 10 to 40 nm.

It is preferable that the carbon black (B) is dispersed so as to have a number average particle diameter of 10 to 40 nm.

It is preferable that dispersion of the carbon black (b) is primary dispersion and the carbon black (B) is dispersed so as to have a number average particle diameter of 10 to 40 nm.

It is preferable that the resin composition further comprises an organophosphorus stabilizer having a melting point of 120 to 250° C.

It is preferable that the resin composition further comprises at least one lubricant selected from the group consisting of esters of C10 to C30 fatty acids and amides of C10 to C30 fatty acids.

It is preferable that a molded product produced from the resin composition has an absorption coefficient of 0.02 to 0.04 ppm⁻¹cm⁻¹

It is preferable that the acrylic resin (A) provides a 3 mm-thick molded product having a total light transmittance of 85% or more.

It is preferable that the acrylic resin (A) contains a rubber-containing acrylic graft copolymer (A1).

It is preferable that 100 parts by weight of the acrylic resin (A) contains 5 to 100 parts by weight of a rubber-containing acrylic graft copolymer (A1) and 95 to 0 parts by weight of an acrylic resin (A2);

the rubber-containing acrylic graft copolymer (A1) is a multilayer graft copolymer having an inner layer of a rubber copolymer (A1c) and an outer layer of a graft component (A1s) with a weight ratio (A1c:A1s) of 5:95 to 85:15, the outer layer covering the inner layer;

the rubber copolymer (A1c) is a polymer of 100% by weight of monomers for rubber copolymer (A1c) containing 50 to 99.9% by weight of an alkyl acrylate, 0 to 49.9% by weight of another copolymerizable vinyl monomer, and 0.1 to 10% by weight of a polyfunctional monomer;

the graft component (A1s) is a polymer of 100% by weight of monomers for graft component (A1s) containing 50 to 100% by weight of an alkyl methacrylate and 0 to 50% by weight of a copolymerizable vinyl monomer other than the alkyl methacrylate; and

the acrylic resin (A2) is a polymer of monomers for acrylic resin containing 0 to 50% by weight of an alkyl acrylate and 100 to 50% by weight of an alkyl methacrylate.

It is preferable that the rubber-containing acrylic graft copolymer (A1) is a multilayer graft copolymer which has at least three layers, which further has an innermost layer polymer (A1a) with a weight ratio (A1a:(sum of A1c and A1s)) of 10:90 to 40:60, and which is obtained by polymerization of the monomers for the rubber copolymer (A1c) in the presence of the innermost layer polymer (A1a); and

the innermost layer polymer (A1a) is a polymer of 100% by weight of monomers for innermost layer polymer containing 40 to 99.9% by weight of one or more monomers selected from the group consisting of alkyl methacrylates and aromatic vinyl compounds, 59.9 to 0% by weight of another copolymerizable vinyl monomer, and 0.1 to 5% by weight of a polyfunctional monomer.

It is preferable that the rubber-containing acrylic graft copolymer (A1) has a number average particle diameter of 30 to 400 nm.

The present invention also relates to a resin molded product which is obtained by molding the resin composition according to the present invention.

It is preferable that the resin molded product has jet-blackness.

The present invention also relates to an automobile component produced from the resin molded product according to the present invention.

It is preferable that the molded product formed into a plate shape by injection molding with a mirror-polished mold has an L value of 0 to 8, the L value being measured with a 0° to 45° spectroscopic color difference meter in conformity with JIS Z 8722.

It is preferable that the difference of L values of the molded product before and after a weather resistance test measured with a color difference meter is between 0 and 1,

the molded product being formed into a plate shape by injection molding with a mirror-polished mold, and

the test being in conformity with JIS K 7350-4 and performed for 1,000 hours under the following conditions: black panel 63° C., with rain, and 255 W/m².

### Effects of Invention

The resin composition of the present invention is excellent in mold-processability, and the molded product thereof is excellent in jet-blackness, weather resistance, gloss, boss strength, abrasion resistance, opaqueness and impact resistance.

Especially, when the acrylic resin provides a 3 mm-thick molded product having a total light transmittance of 85% or more, and when the carbon black dispersed in the resin composition has a number average particle diameter of 10 to 40 nm, an excellent jet-blackness is achieved.

### BRIEF DESCRIPTION OF DRAWINGS

FIG. 1 is a transmission electron microscope (TEM) picture of a molded product of Experimental Example 36.

FIG. 2 is a transmission electron microscope (TEM) picture of a sample of a composition (CB-7) containing a masterbatch (CB-6) of carbon black.

FIG. 3 is a transmission electron microscope (TEM) picture of a sample of a composition (CB-8).

### DESCRIPTION OF EMBODIMENTS

### (Resin Composition)

The resin composition of the present invention contains an acrylic resin (A) and a carbon black (B) having a number average particle diameter of 10 to 40 nm.

### (Acrylic Resin (A))

In the present invention, a thermoplastic resin is used as the acrylic resin (A). Acrylic resins have particularly excellent transparency and favorable impact resistance. Additionally, the acrylic resins allow the resin molded product to have especially excellent black appearance.

Acrylic resins may include partially modified resins. Examples thereof include resins modified with imide, such as maleimide-modified acrylic resins.

A total light transmittance of a 3 mm-thick molded product produced from the acrylic resin (A) is preferably not less than 85% and more preferably not less than 90% from the viewpoint of imparting excellent jet-blackness or favorable opaqueness. The wavelength of light for measurement of the total light transmittance is 380 to 780 nm.

The acrylic resin preferably includes a rubber modified acrylic resin from the viewpoint of achieving excellent impact resistance and the like.

### (Rubber Modified Acrylic Resin)

In order to achieve excellent impact strength, 100% by weight in total of the acrylic resin preferably contains 5 to 100% by weight of a rubber-containing acrylic graft copolymer (A1) and 95 to 0% by weight of an acrylic resin (A2). The contents of the rubber-containing acrylic graft copolymers (A1) and the acrylic resin (A2) in the acrylic resin are more preferably 10 to 50% by weight and 90 to 50% by weight, respectively.

In the case of a molded product having a specific absorption coefficient described later, the rubber modified acrylic resin preferably contains 10 to 40% by weight of the rubber-containing acrylic graft copolymers (A1), 60 to 90% by weight of the acrylic resin (A2), and 0 to 5% by weight of other materials. Examples of the other materials include ultraviolet absorbers, light stabilizers, various antioxidants, and colorants other than the carbon black described below.

### (Rubber-Containing Acrylic Graft Copolymer (A1))

In order to achieve excellent impact strength and transparency, the rubber-containing acrylic graft copolymer (A1) is preferably a multilayer graft copolymer having a rubber copolymer (A1c) inner layer and a graft component (A1s) outer layer covering the inner layer with a weight ratio A1c:A1s of 5:95 to 85:15. In order to achieve higher impact strength, the weight ratio A1c:A1s is more preferably 25:75 to 80:20.

In order to achieve particularly excellent impact strength and transparency, the copolymer (A1) is more preferably a multilayer graft copolymer having at least three layers, which further has an innermost layer polymer (A1a) with a weight ratio A1a:(sum of A1c and A1s) of 10:90 to 40:60 and which is obtained by polymerizing monomers for the rubber copolymer (A1c) in the presence of this innermost layer polymer (A1a).

From the viewpoint of the balance of impact resistance and transparency, the number average particle diameter of the rubber-containing acrylic graft copolymer (A1) is preferably 30 to 400 nm, and more preferably 40 to 300 nm.

A method for producing such a rubber-containing acrylic graft copolymer (A1) is not particularly limited. Examples thereof include suspension polymerization and emulsion polymerization. The copolymer (A1) is preferably produced by emulsion polymerization because better effects can be achieved by making the particle diameter of copolymer particles uniform.

Since the impact resistance can be significantly increased while the transparency of the acrylic resin is maintained, acrylic rubber-containing acrylic graft copolymers supplied by Kaneka Corporation, for example, may be used as the rubber-containing acrylic graft copolymer (A1).

As mentioned above, the composition of the present invention preferably contains a specific amount of a specific rubber-containing acrylic graft copolymer which is well dispersed in a base resin, as well as the carbon black, and which has excellent effects of imparting transparency and impact resistance. Thus, the composition is excellent not only in light resistance but also in water resistance because the possibility of hydrolysis of the base resin is reduced.

### (Rubber Copolymer (A1c))

The rubber copolymer (A1c) is a constituent which mainly gives an effect of improving impact resistance owing to its rubber elasticity.

In order to achieve excellent impact strength and transparency, the rubber copolymer (A1c) is preferably a polymer of monomers for rubber copolymer containing 50 to 99.9% by weight of an alkyl acrylate, 0 to 49.9% by weight of a copolymerizable vinyl monomer other than the alkyl acrylate, and 0.1 to 10% by weight of a polyfunctional monomer. It is more preferably a polymer of monomers for rubber copolymer containing 70 to 99% by weight of an alkyl acrylate, 0 to 29% by weight of a copolymerizable vinyl monomer other than the alkyl acrylate, and 0.1 to 5% by weight of a polyfunctional monomer.

The rubber copolymers (A1c) generally have a number average molecular weight of 500 to 100000.

The transparency of the acrylic resin (A) increases as the refractive index of the rubber copolymer (A1c) is closer to those of the graft component (A1s) and the acrylic resin (A2) and its particle size is smaller.

From the viewpoint of the balance of impact resistance and transparency, the number average particle diameter of such a rubber copolymer (A1c) is preferably 30 to 400 nm, and more preferably 40 to 300 nm.

### (Graft Component (A1s))

In order to achieve excellent impact strength, transparency, and mold-processability, the graft component (A1s) is preferably a polymer of monomers for graft component containing 50 to 100% by weight of an alkyl methacrylate and 0 to 50% by weight of a copolymerizable vinyl monomer other than the alkyl methacrylate. It is more preferably a polymer of monomers for graft component containing 80 to 100% by weight of an alkyl methacrylate and 20 to 0% by weight of a copolymerizable vinyl monomer other than the alkyl methacrylate. In order to improve the fluidity of the resin composition of the present invention and further improve the mold-processability thereof, it is preferable to add 0.01 to 5 parts by weight of a mercaptan compound such as dodecyl mercaptan or octyl mercaptan to 100 parts by weight of the monomers for graft component.

This graft component (A1s) itself may be a multilayer component, if necessary.

### (Innermost Layer Polymer (A1a))

The innermost layer polymer (A1a) is a constituent for the purpose of further improving the impact strength and transparency of the resin composition of the present invention.

The innermost layer polymer (A1a) is preferably a polymer of monomers for innermost layer polymer including 40 to 99.9% by weight of one or more monomers selected from the group consisting of alkyl methacrylates and aromatic vinyl compounds, 59.9 to 0% by weight of another copolymerizable vinyl monomer, and 0.1 to 5% by weight of a polyfunctional monomer. The polymer (A1a) is more preferably a polymer of monomers for innermost layer polymer including 55 to 90% by weight of one or more monomers selected from the group consisting of alkyl methacrylates and aromatic vinyl compounds, 45 to 10% by weight of another copolymerizable vinyl monomer, and 0.1 to 5% by weight of a polyfunctional monomer.

Polymerization of the monomers for the rubber copolymer in the presence of this innermost layer polymer (A1a) makes the innermost layer polymer (A1a) be a layer mainly distributed at the center portion of the rubber-containing acrylic graft copolymer (A1).

### (Monomers)

From the viewpoint of the polymerization reaction rate, the alkyl acrylate is preferably one having a C1-C8 alkyl group. Examples thereof include methyl acrylate, ethyl acrylate, propyl acrylate, butyl acrylate (BA), 2-ethylhexyl acrylate (2EHA), and n-octyl acrylate (nOA). In order to improve impact resistance, the alkyl acrylate is preferably at least one selected from the group consisting of BA, 2EHA, and nOA, and is particularly preferably BA. Each of these may be used alone, or two or more of these may be used in combination. The alkyl group in the alkyl acrylate may have a straight chain or a branched chain.

Examples of the copolymerizable vinyl monomers other than the acrylic acid alkyl ester include aromatic vinyl compounds such as styrene, α-methyl styrene, and vinyl toluene; methacrylic acid alkyl esters such as methyl methacrylate, ethyl methacrylate, propyl methacrylate, and butyl methacrylate; non-alkyl (meth)acrylates such as phenyl (meth)acrylate, cyclohexyl (meth)acrylate, and benzyl (meth)acrylate; (meth)acrylonitrile; and (meth) acrylic acid.

The term “(meth)acrylate” herein refers to “acrylate and/or methacrylate”. Similarly, “(meth)acrylonitrile” and “(meth)acrylic acid” refers to “acrylonitrile and/or methacrylonitrile” and “acrylic acid and/or methacrylic acid”, respectively.

The polyfunctional monomer is a monomer having two or more non-conjugated double bonds per molecule, and is a component which serves as a crosslinking agent or a grafting agent. From the viewpoint of crosslinking ability, the polyfunctional monomer is preferably one or more selected from the group consisting of alkylene glycol di(meth)acrylates, vinyl group-containing polyfunctional monomers, and allyl group-containing polyfunctional monomers.

Examples of the alkylene glycol di(meth)acrylates include ethylene glycol di(meth)acrylate, diethylene glycol di(meth)acrylate, dipropylene glycol di(meth)acrylate, and dibutylene glycol di(meth)acrylate. Examples of the vinyl group-containing polyfunctional monomers include divinylbenzene and divinyl adipate. Examples of the allyl group-containing polyfunctional monomers include allyl (meth)acrylate, diallyl phthalate, triallyl cyanurate, and triallyl isocyanurate.

From the viewpoint of the polymerization reaction rate, the alkyl methacrylate is preferably one having a C1-C4 alkyl group. Examples thereof include methyl methacrylate, ethyl methacrylate, propyl methacrylate, and butyl methacrylate. In order to improve processability, methyl methacrylate is preferable. The alkyl group in the alkyl methacrylate may have a straight chain or a branched chain.

Examples of the copolymerizable vinyl monomers other than the methacrylic acid alkyl ester include aromatic vinyl compounds such as styrene, α-methyl styrene, and vinyl toluene; acrylic acid alkyl esters such as methyl acrylate, ethyl acrylate, propyl acrylate, and butyl acrylate; non-alkyl (meth)acrylates such as phenyl (meth)acrylate, cyclohexyl (meth)acrylate, and benzyl (meth)acrylate; (meth)acrylonitrile; and (meth)acrylic acid.

The aromatic vinyl compound is preferably one or more selected from the group consisting of styrene, α-methyl styrene, and vinyl toluene, and is more preferably styrene.

Examples of the another copolymerizable vinyl monomer include aromatic vinyl compounds such as styrene, α-methyl styrene, and vinyl toluene; alkyl (meth)acrylates such as methyl (meth)acrylate, ethyl (meth)acrylate, propyl (meth)acrylate, and butyl (meth)acrylate; non-alkyl (meth)acrylates such as phenyl (meth)acrylate, cyclohexyl (meth)acrylate, and benzyl (meth)acrylate; (meth)acrylonitrile; and (meth)acrylic acid.

### (Acrylic Resin (A2))

The acrylic resin (A2) is a constituent serving as a base resin of the resin composition of the present invention which forms a continuous layer resin, namely a matrix resin, containing the rubber-containing acrylic graft copolymer (A1) and the carbon black (B).

In order to achieve excellent transparency, the acrylic resin (A2) is preferably a polymer of monomers for acrylic resin containing 0 to 50% by weight of an alkyl acrylate and 100 to 50% by weight of an alkyl methacrylate.

The acrylic resin (A2) has a number average molecular weight of preferably 5,000 to 150,000, and more preferably 9,000 to 120,000.

A method for producing such an acrylic resin (A2) is not particularly limited. Examples thereof include suspension polymerization and emulsion polymerization. In order to efficiently copolymerize an alkyl methacrylate and an alkyl acrylate, suspension polymerization is preferable.

Those mentioned above may be respectively used as an acrylic acid alkyl ester and a methacrylic acid alkyl ester.

### (Carbon Black (B))

The resin composition according to the present invention contains a carbon black (B) having a number average particle diameter of 10 to 40 nm.

In production of a jet-black molded product, from the viewpoint of imparting sufficient jet-blackness to the rubber-modified acrylic resin composition of the present invention, the number average particle diameter is preferably 10 to 30 nm, more preferably 10 to 25 nm, and most preferably 10 to 20 nm. A carbon black having a number average particle diameter of more than 40 nm may not exhibit sufficient jet-blackness. A carbon black having a number average particle diameter of less than 10 nm may easily aggregate, though it favorably imparts jet-blackness. In addition, such a carbon black is hardly available because particle size separation thereof is commonly difficult.

In production of a resin molded product having a specific absorption coefficient according to the present invention, from the viewpoint of imparting excellent black appearance to the resin composition, namely, from the viewpoint of dispersing the carbon black (B) such that the molded product has a specific absorption coefficient, the number average particle diameter of the carbon black (B) is preferably 10 to 30 nm, and more preferably 10 to 20 nm. The carbon black (B) having a number average particle diameter of more than 40 nm may hardly allow a molded product to have a specific absorption coefficient. Also, there may be a case where a resin molded product having blackness without nonuniform color tone and having opaqueness is hardly obtained. The carbon black having a number average particle diameter of less than 10 nm is hardly available, though it favorably imparts opaqueness.

The carbon black (B) is preferably dispersed in the resin composition so as to have a number average particle diameter of 10 to 40 nm. Dispersion of the carbon black is more preferably primary dispersion from the viewpoint of black coloring. The “primary dispersion” refers to a state where particles of the carbon black are primary particles, that is, a state where ultimate particles (unit particles) are dispersed without aggregation with other particles. In the case of the carbon black, though particles thereof do not have a perfect spherical shape, primary dispersion can be confirmed by observation using a TEM.

In order to impart sufficient jet-blackness to the molded product, an average particle diameter of the carbon black, namely the dispersion particle diameter, is more preferably 10 to 30 nm, further preferably 10 to 25 nm, and most preferably 10 to 20 nm. Carbon black with a dispersion particle diameter larger than 40 nm is not preferable because it fails to impart sufficient jet-blackness. In addition, it is generally difficult to obtain carbon black with the dispersion particle diameter smaller than 10 nm although it has an excellent effect of imparting jet-blackness.

In production of a molded product having a specific absorption coefficient according to the present invention, the diameter of dispersed particles (the dispersion particle diameter) of the carbon black is more preferably 10 to 30 nm, and still more preferably 10 to 20 nm for the same reason as mentioned above.

In the present invention, the average particle diameter is determined by observing carbon black aggregates using an electron microscope and measuring the sizes of the components which cannot be separated any more while maintaining their outlines, and calculating the arithmetic mean of the sizes under the condition of N=50 particles.

The carbon black is preferably one having a degree of blackness equal to or above that of MCF (medium colour furnace) (that is, HCF: high colour furnace or HCC: high colour channel) which is a general name of colorant carbon black. Examples thereof include, but not limited to, MITSUBISHI Carbon Black (registered trademark) grades #2600, #980, and #960 (Mitsubishi Chemical Corporation); TOKABLACK (registered trademark) grades #8500, #7400, #7350, and #7100 (Tokai Carbon Co., Ltd.); Colour Black (registered trademark) grades FW200, FW2, and 5170, and Printex (registered trademark) grades 90 and 80 (Evonik Degussa GmbH); and Raven (registered trademark) grades 7000, 5750, and 3500 (Columbian Chemicals Company), Monarch (registered trademark) grades 1400, 1300, 900, and 800, Black Pearls (registered trademark) grades 1400, 1300, 900, and 800, and Vulcan (registered trademark) grade P (Cabot Corporation).

Carbon black may be supplied in a powder form or in a granulated form. From the viewpoint of the dispersibility of the carbon black, it is preferable to use what is called a masterbatch pigment, which is prepared for example by preliminarily kneading an acrylic resin and carbon black in high concentration and then pulverizing the kneaded mass, rather than to add the carbon black as it is.

The acrylic resin used in production of a masterbatch has a molecular weight preferably of 50,000 to 150,000, and more preferably of 90,000 to 120,000. The molecular weight of less than 50,000 tends to easily cause lowering of the molecular weight during production of a masterbatch and during production of a pellet. The molecular weight of more than 150,000 tends to reduce flowability, resulting in hard injection molding.

For production of a resin molded product having a specific absorption coefficient according to the present invention, use of a masterbatch having a low carbon black content for final molding is preferable from the viewpoint of quality stability of opaqueness, and stability of dispersibility, measurement and quality of the carbon black. Such a masterbatch is prepared, for example, by lowering the concentration of the carbon black in two or more steps, namely by repeating a procedure of pre-kneading and pulverizing.

In order to impart sufficient jet-blackness, the amount of the carbon black is preferably 0.05 to 10 parts by weight, and more preferably 0.1 to 5 parts by weight with respect to 100 parts by weight of the acrylic resin (A). More than 10 parts by weight of carbon black is uneconomical since the degree of jet-blackness is saturated.

In production of a resin molded product having a specific absorption coefficient, in order to impart blackness, the amount of the carbon black is preferably 0.001 to 0.1 parts by weight for 100 parts by weight of the acrylic resin (A). In order to impart opaqueness, the amount of the carbon black is more preferably 0.001 to 0.05 parts by weight, namely 10 to 500 ppm by weight, still more preferably 20 to 300 ppm by weight, even more preferably 40 to 250 ppm by weight, and particularly preferably 40 to 100 ppm by weight.

In order to produce a resin molded product having excellent black appearance in the present invention, coloring is preferably performed only with the carbon black (B). Other colors and dyes may be used for coloring within a range that the required weather resistance can be maintained (range that ΔE is less than 3 under the conditions of exposure using a sunshine weather meter (with rain, black panel temperature of 63° C.) for 2000 hours). It is to be noted that excessive use of colors and dyes may cause failure in production of a resin molded product having excellent long-term black appearance due to lowering of weather resistance of the colors and dyes themselves and the weather resistance of the base resin in the presence of the colors and dyes.

### (Organophosphorus Stabilizer)

The resin composition of the present invention preferably further contains an organophosphorus stabilizer having a melting point (mp) of 120 to 250° C. In production of a resin molded product of the present invention from the resin composition, molding is performed at high temperature for improving processability of the resin composition, and the residence time of the resin composition tends to be long in a large molding machine. Use of an organophosphorus stabilizer particularly improves heat stability during processing, resulting in production of a molded product having excellent jet-black appearance. In order to achieve the above effect during processing and to prevent bleed out, the organophosphorus stabilizer preferably has a melting point of 140 to 200° C.

Preferable examples of such organophosphorus stabilizers include 2,2′-methylene bis(4,6-di-t-butylphenyl)octylphosphite (mp of 146 to 152° C., e.g., HP-10 from ADEKA CORPORATION), tris(2,4-di-t-butylphenyl)phosphite (mp of 180 to 190° C., e.g., IRGAFOS 168 from BASF, ADK STAB 2112 from ADEKA CORPORATION), bis(2,6-di-t-butyl-4-methylphenyl)pentaerythritol diphosphite (mp of 234 to 240° C., e.g., PEP-36 from ADEKA CORPORATION), and 2-[[2,4,8,10-tetrakis(1,1-dimethylethyl)dibenzo[d,f][1,3,2]dioxaphosphepin-6-yl]oxy]-N,N-bis[2-[[2,4,8,10-tetrakis(1,1-dimethylethyl)dibenzo[d,f][1,3,2]dioxaphosphepin-6-yl]oxy]-ethyl]ethanamine (mp of 190 to 210° C., e.g., IRGAFOS 12 from BASF).

The amount of the organophosphorus stabilizer added is preferably 0.01 to 3 parts by weight, more preferably 0.05 to 1 part by weight, and still more preferably 0.1 to 0.5 parts by weight for 100 parts by weight of the acrylic resin (A).

### (Lubricant)

The resin composition of the present invention preferably further contains at least one lubricant selected from the group consisting of esters of C10 to C30 fatty acids and amides of C10 to C30 fatty acids, from the viewpoint of enhancement of abrasion resistance while maintaining jet-blackness of the molded product, and also from the viewpoint of appropriate compatibility with the acrylic resin (A) and balance with external lubrication to some extent.

Examples of the fatty acid esters (including fatty acid partial esters of polyalcohol) include montanic acid ester, butyl oleate, butyl stearate, hydrogenated castor oil, ethylene glycol monostearate, glyceryl monooleate, glyceryl monostearate, and sorbitan monolaurate.

Examples of the fatty acid amides include oleic amide, stearamide, palmitic acid amide, methylenebisstearamide, and ethylenebisstearamide.

Among them, more preferable is at least one selected from the group consisting of ethylene glycol esters of C10 to C30 fatty acids and C10 to C30 alcohol esters of C10 to C30 fatty acids, and still more preferable is ethylene glycol esters of C10 to C30 fatty acids. Examples of the ethylene glycol esters of C10 to C30 fatty acids include ethylene glycol esters of montanic acid and of stearic acid. More preferable is ethylene glycol esters of montanic acid.

The amount of the lubricant added is preferably 0.1 to 10 parts by weight, and more preferably 0.5 to 5 parts by weight for 100 parts by weight of the acrylic resin. If the amount is less than 0.1 parts by weight, the effect of the lubricant is hardly exhibited. If the amount is more than 10 parts by weight, jet-blackness and physical properties of the molded product may be lowered.

Other lubricants such as aliphatic hydrocarbons, aliphatic alcohols, fatty acids, metal soap, and silicone oil may be used in combination.

Examples of the aliphatic hydrocarbons include liquid paraffin, native paraffin, synthetic paraffin, micro wax (micro crystalline wax), polyethylene wax; and partial oxides, fluorides, and chlorides of these. Examples of the aliphatic alcohols include cetyl alcohol, lauryl alcohol, stearyl alcohol, oleyl alcohol, and mixed aliphatic alcohols. Examples of the fatty acids include lauric acid, stearic acid, mixed fatty acids (fatty acids of beef tallow, fish oil, coconut oil, soybean oil, rape seed oil, rice bran oil and the like). Examples of the metal soap include barium stearate, zinc stearate, calcium stearate, lead stearate, aluminum stearate, and magnesium stearate. Examples of the silicone oil include silicone oil mainly containing polydimethylsiloxane. Further among such silicone oil, modified silicone oil of carboxylic acid group-containing silicone oil and hydroxyl group-containing silicone oil may be exemplified.

### (Other Additives)

The resin composition of the present invention may optionally further contain various ultraviolet absorbers, light stabilizers, antioxidants, colorants other than the carbon black, stabilizers other than organophosphorus stabilizers, or the like.

### (Ultraviolet Absorber)

In order to further improve weather resistance, the resin composition of the present invention preferably contains an ultraviolet absorber in an amount which does not affect the total light transmittance of the molded product of the resin composition. Namely, the amount thereof is preferably 0.1 to 15 parts by weight, and more preferably 0.2 to 5 parts by weight, with respect to 100 parts by weight of the acrylic resin (A).

From the viewpoint of its ultraviolet absorption ability, the ultraviolet absorber is preferably one or more selected from the group consisting of benzotriazole ultraviolet absorbers, triazine ultraviolet absorbers, and benzophenone ultraviolet absorbers. Examples of the benzotriazole ultraviolet absorbers include 2-(2-hydroxy-5-methylphenyl)benzotriazole, 2-[2-hydroxy-5-(1,1,3,3-tetramethylbutyl)phenyl]benzotriazole, 2-[2-hydroxy-3,5-bis(α,α-dimethylbenzyl)phenyl]benzotriazole, 2-(2′-hydroxy-3-tert-butyl-5′-methylphenyl)-5-chlorobenzotriazole, 2-(2-hydroxy-3,5-di-tert-amylphenyl)benzotriazole, 2-(2-hydroxy-3-sec-butyl-5-tert-butylphenyl)benzotriazole, 2,2′-methylenebis[6-(2H-benzotriazol-2-yl)-4-(1,1,3,3-tetramethylbutyl)phenol], and 2-(2-hydroxy-5-methyl-3-dodecylphenyl)benzotriazole. Examples of the triazine ultraviolet absorbers include 2-(4,6-diphenyl-1,3,5-triazin-2-yl)-5-[(hexyl)oxy]-phenol. Examples of the benzophenone ultraviolet absorbers include 2-hydroxy-4-phenylmethoxybenzophenone, 2-hydroxy-4-methoxy-5-sulfoxy trihydrate benzophenone, and 2-hydroxy-4-phenylpropoxybenzophenone.

### (Light Stabilizer)

In order to further improve weather resistance, the resin composition preferably contains a light stabilizer in an amount of 0.1 to 3 parts by weight with respect to 100 parts by weight of the acrylic resin (A).

The light stabilizer is not particularly limited and a known light stabilizer may be used. Examples thereof include 2,2,6,6-tetramethyl-4-piperidyl stearate, 2,2,6,6-tetramethyl-4-piperidyl benzoate, 1,2,2,6,6-pentamethyl-4-piperidyl stearate, N-(2,2,6,6-tetramethyl-4-piperidyl)dodecyl succinimide, 1,2,2,6,6-pentamethyl-4-piperidyl benzoate, 1,2,2,6,6-pentamethyl-4-piperidyl methacrylate, bis(2,2,6,6-tetramethyl-4-piperidyl)sebacate, bis(1,2,2,6,6-pentamethyl-4-piperidyl)sebacate, bis(1-octoxy-2,2,6,6-tetramethyl-4-piperidyl)sebacate, bis(2,2,6,6-tetramethyl-4-piperidyl)bis(tridecyl)-1,2,3,4-butanetetracarboxylate, bis(1,2,2,6,6-pentamethyl-4-piperidyl)bis(tridecyl)-1,2,3,4-butanetetracarboxylate, bis(1,2,2,6,6-pentamethyl-4-piperidyl)-2-butyl-2-(3,5-di-tert-butyl-4-hydroxyphenylmethyl)malonate, tetrakis(2,2,6,6-tetramethyl-4-piperidyl)-1,2,3,4-butanetetracarboxylate, tetrakis(1,2,2,6,6-pentamethyl-4-piperidyl)-1,2,3,4-butanetetracarboxylate, 3,9-bis[1,1-dimethyl-2-[tris(2,2,6,6-tetramethyl-4-piperidyloxycarbonyloxy)butylcarbonyloxy]ethyl]-2,4,8,10-tetraoxaspiro[5.5]undecane, 3,9-bis[1,1-dimethyl-2-[tris(1,2,2,6,6-pentamethyl-4-piperidyloxycarbonyloxy)butylcarbonyloxy]ethyl]-2,4,8,10-tetraoxaspiro[5.5]undecane, 1-[(3,5-di-tert-butyl-4-hydroxyphenyl)propionyloxyethyl]-2,2,6,6-tetramethyl-4-piperidyl-(3,5-di-tert-butyl-4-hydroxyphenyl)propionate, a condensate of 1-(2-hydroxyethyl)-2,2,6,6-tetramethyl-4-piperidinol/dimethyl succinate, a condensate of 2-tert-octylamino-4,6-dichloro-s-triazine/N,N′-bis(2,2,6,6-tetramethyl-4-piperidyl)hexamethylenediamine, a condensate of N,N′-bis(2,2,6,6-tetramethyl-4-piperidyl)hexamethylenediamine/dibromoethane, 2,2,6,6-tetramethyl-4-hydroxypiperidine-N-oxyl, a polycondensate of 1,6-bis(2,2,6,6-tetramethyl-4-piperidylamino)hexane/dibromoethane, a polycondensate of 1,6-bis(2,2,6,6-tetramethyl-4-piperidylamino)hexane/2,4-dichloro-6-tert-octylamino-s-triazine, and a polycondensate of 1,6-bis(2,2,6,6-tetramethyl-4-piperidylamino)hexane/2,4-dichloro-6-morpholino-s-triazine.

### (Resin Molded Product)

The resin molded product of the present invention is produced by molding the resin composition of the present invention and has excellent blackness, namely excellent black appearance.

In the present invention, a molded product having excellent jet-blackness refers to a product having an L value of 6.5 or smaller defined by JIS Z-8729. The L value is more preferably 6 or smaller. The L value is determined by irradiating a measurement surface of a resin molded product with light from straight above (90°) and measuring light reflected in a direction of 45° from the measurement surface.

In the case where the resin molded product produced from the resin composition of the present invention has an absorption coefficient of 0.02 to 0.04 ppm⁻¹cm⁻¹, the resin molded product has excellent black appearance and excellent opaqueness.

The absorption coefficient is determined by Equation 1 below.

Absorption coefficient={log₁₀(I₀/I)}/(C×L) (Equation 1)

In Equation 1, “C” indicates weight concentration (ppm) of the carbon black (B) in the resin (A), “I” indicates parallel light transmittance of the resin molded product, “I₀” indicates parallel light transmittance of a resin molded product in the same shape as the resin molded product and not containing the carbon black (B), “L” indicates thickness (cm) of the resin molded product in the incident direction of the parallel light to the resin molded product.

In the case where the acrylic resin (A) is a rubber modified acrylic resin, the excellent glass-like appearance peculiar to acrylic resins, such as transparency and gloss, contributes to excellent black appearance synergistically with the carbon black (B) dispersed so as to have the specific absorption coefficient. In addition, the resin molded product of the present invention can be imparted with excellent weather resistance, gloss, and impact resistance.

The resin molded product having the specific absorption coefficient has a total light transmittance preferably of 1 to 80%, and more preferably of 30 to 80% for the purpose of achieving excellent semi-transmittance of light, namely, excellent opaqueness and rich appearance at the same time.

The resin molded product having the specific absorption coefficient is allowed to have a small L value by forming it into a plate having two main planes and four side planes wherein one main plane has a mirror finished surface and the other main plane and four side planes each have a pearskin finished surface.

The molded product of the present invention formed into a plate shape by injection molding with a mirror-polished mold preferably has an L value of 0 to 8. Here, the L value is measured with a 0° to 45° spectroscopic color difference meter in conformity with JIS Z 8722.

Further, the difference of L values of the plate-shaped molded product before and after a weather resistance test is preferably between 0 and 1. Here, the molded product is formed by injection-molding with a mirror-polished mold. The L values are measured with a color difference meter, and the test is in conformity with JIS K 7350-4 and performed for 1,000 hours under the following conditions: black panel 63° C., with rain, and 255 W/m².

The resin composition of the present invention has excellent black appearance and mold-processability and therefore can be suitably used for producing housing and building applications, automobile component, electric and electronic components, sundries, films, or the like when molded by a known molding method of thermoplastic resins, such as injection molding and extrusion molding. The molded product is excellent not only in weather resistance, impact resistance, and appearance, but also in blackness and gloss. Accordingly, the molded product is suitable as, for example, appearance components required to have sophisticated appearance and can be used for automobile component, household electrical appliance parts, furniture parts, OA housing applications, and film applications, as such appearance components.

### (Automobile Component)

The resin molded product of the present invention can be used as an automobile component of the present invention, and applicable to both an exterior part and an interior part. For example, jet-black molded products may be favorably used as covers (e.g., pillar cover), pillar garnishes, rear garnishes, rear spoilers, switch covers, garnishes (e.g., interior garnish disposed around console), parts around hoods (e.g., hood upper part), and radiator grilles. In the case of the resin molded products having the specific absorption coefficient and semi-transmittance of light, such products may be favorably used for side visors, roof visors, and sunroofs.

Use of the resin molded product of the present invention allows the resulting automobile components to be excellent not only in weather resistance and gloss, but also in uniform blackness, namely black appearance, even in the case of a large injection molded product, impact resistance, and boss strength. Also the resin molded product of the present invention is suitably used for an automobile component required to have sophisticated appearance and excellent abrasion resistance.

### EXAMPLES

The following will discuss the present invention in more detail with reference to experimental examples. The present invention is not limited only to these experimental examples.

### Preparation of Rubber Copolymer A1c-1

A glass reactor was charged with ion exchange water (250.0 parts by weight), potassium stearate (0.5 parts by weight), sodium formaldehyde sulfoxylate (0.2 parts by weight), disodium ethylenediaminetetraacetate (0.01 parts by weight), and ferrous sulfate heptahydrate (0.005 parts by weight). The substances were heated up to 40° C. while being stirred under nitrogen flow. A mixture of monomers for rubber copolymer including n-butyl acrylate (BA, 84 parts by weight), styrene (ST, 15 parts by weight), and allyl methacrylate (ALMA, 1 part by weight) and cumene hydroperoxide (CHP, 0.1 parts by weight) was added dropwise over 4 hours. At the same time of the dropwise addition, a 5% by weight solution of potassium stearate in water (40 parts by weight, containing 2 parts by weight of potassium stearate) was continuously added over 4 hours. After the addition was finished, stirring was continued for 1.5 hours and the polymerization was completed. Thereby, latex of a rubber copolymer A1c-1 was obtained. The polymerization conversion was 98% (amount of polymer/amount of monomers×100(%)). In the obtained latex of the rubber copolymer A1c-1, the rubber copolymer particles had a number average particle diameter of 70 nm (determined by utilizing light scattering at a wavelength of 546 nm).

### Preparation of Rubber Copolymer A1c-2

Latex of a rubber copolymer A1c-2 was obtained in the same manner as in the aforementioned section (Preparation of rubber copolymer A1c-1) except that: 0.05 parts by weight of potassium stearate was used instead of 0.5 parts by weight of potassium stearate; BA (99 parts by weight) and ALMA (1 parts by weight) were used as monomers for rubber copolymer and a mixture of the monomers for rubber copolymer and cumene hydroperoxide (0.1 parts by weight) was prepared; 10% of this mixture was collectively added and polymerization was allowed to proceed for 1 hour and then the remaining 90% of the mixture was added dropwise over 4 hours; at the same time of the dropwise addition, a 5% by weight solution of potassium stearate in water (30 parts by weight, containing 1.5 parts by weight of potassium stearate) was continuously added over 4 hours; and after the addition was finished, stirring was continued for 1.5 hours and the polymerization was completed. The polymerization conversion was 97.5% (amount of polymer/amount of monomers×100(%)). In the obtained latex of the rubber copolymer A1c-2, the rubber copolymer particles had a number average particle diameter of 220 nm (determined by utilizing light scattering at a wavelength of 546 nm).

### Production of Rubber-Containing Acrylic Graft Copolymers A1-1 to A1-4

A glass reactor was charged with ion exchange water (220.0 parts by weight), latex of a rubber copolymer shown in Table 1 (solid amount in parts by weight shown in Table 1), sodium formaldehyde sulfoxylate (0.05 parts by weight), disodium ethylenediaminetetraacetate (0.01 parts by weight), and ferrous sulfate heptahydrate (0.005 parts by weight). The substances were stirred under nitrogen flow to prepare an aqueous dispersion, and the dispersion was heated up to 60° C. while its state was maintained. A mixture with a graft composition shown in Table 1, that is, a mixture of monomers for graft component (methyl methacrylate (MMA), BA, and methyl acrylate (MA)), a polymerization initiator (CHP), and normal-dodecyl mercaptan (n-DM), each in amounts (parts by weight) shown in Table 1, was continuously added over 2 hours. After the addition was finished, CHP (0.01 parts by weight) was further added. Stirring was continued for 1 hour and the polymerization was completed. Thereby, latex of the corresponding rubber-containing acrylic graft copolymer (each of A1-1 to A1-4) was obtained. The polymerization conversion was 99%. The obtained rubber-containing acrylic graft copolymers each had a multilayer structure consisting of an inner layer of the rubber copolymer (A1c) and an outer layer of the graft component (A1s) covering the inner layer. These latexes were subjected to curing salting, heat-treatment, and drying of known methods and thereby formed into white powders. As a result, the corresponding rubber-containing acrylic graft copolymers A1-1 to A1-4 were obtained.

Here, in the production of the latex of the copolymer A1-4, potassium stearate (0.5 parts by weight) was additionally added in the middle of the 2-hour addition, that is, 1 hour after starting the addition, of the mixture with the aforementioned graft composition including the monomers for graft component and the polymerization initiator.

TABLE 1

| | | A1-1 | A1-2 | A1-3 | A1-4 |
|---|---|---|---|---|---|
| Rubber copolymer | A1c-1 | 75 | 75 | 50 | |
| (solid) | A1c-2 | | | | 75 |
| Graft composition | MMA | 20 | 27 | 45 | 20 |
| | BA | 5 | | | 5 |
| | MA | | 3 | 5 | |
| | CHP | 0.05 | 0.05 | 0.1 | 0.05 |
| | n-DM | | | 0.25 | |

(unit: parts by weight)

### Production of Three-Layer Rubber-Containing Acrylic Graft Copolymers A1-5 to A1-8

In order to prepare the innermost layer polymer (A1a), the following process was performed. A glass reactor was charged with ion exchange water (220.0 parts by weight), boric acid (0.3 parts by weight), sodium carbonate (0.03 parts by weight), sodium N-lauroylsarcosinate (0.09 parts by weight), sodium formaldehyde sulfoxylate (0.09 parts by weight), disodium ethylenediaminetetraacetate (0.006 parts by weight), and ferrous sulfate heptahydrate (0.002 parts by weight). The substances were heated up to 80° C. while being stirred under nitrogen flow. Then, a mixed solution of the inner layer component was prepared from monomers for innermost layer polymer shown in Table 2 and t-butyl hydroperoxide (0.1 parts by weight). First, 25% of the solution was collectively charged and polymerization was allowed to proceed for 45 minutes. Next, the remaining 75% of this solution was continuously added over 1 hour. After the addition was finished, the mixture was maintained at the same temperature for 2 hours and the polymerization was completed. Thereby, latex of the corresponding three-layer rubber-containing acrylic graft copolymer (each of A1-5 to A1-8) as the innermost layer polymer (A1a) was obtained. Here, during the 1-hour continuous addition of the monomers, sodium N-lauroylsarcosinate (0.2 parts by weight) was additionally added. The obtained latex of the innermost layer polymer (A1a) was a cross-linked methacrylic polymer latex. The polymer particles therein had a number average particle diameter of 160 nm, and the polymerization conversion was 98%. Exceptionally, the innermost layer polymer particles of A1-8 had a number average particle diameter of 135 nm.

In order to prepare the rubber copolymer (A1c), the following process was performed. The aforementioned obtained latex of the innermost layer polymer (A1a) was maintained at 80° C. under nitrogen flow. Potassium persulfate (0.1 parts by weight) was added thereto, and then monomers for rubber copolymer shown in Table 2 were continuously added over 5 hours. During this 5-hour addition, potassium oleate (0.1 parts by weight in total) was added in three portions. After the addition was finished, potassium persulfate (0.05 parts by weight) was further added so as to complete the polymerization and the mixture was maintained for 2 hours. Thereby, latex of polymer particles having a bilayer structure of the innermost layer polymer (A1a) and the rubber copolymer (A1c) was obtained. The obtained bilayer polymer particles had a number average particle diameter shown in Table 2, and the polymerization conversion was 99% in every case.

In order to prepare the graft component (A1s), the following process was performed. The aforementioned latex of the bilayer polymer particles was kept at 80° C. Potassium persulfate (0.02 parts by weight) was added thereto, and then a mixture with a graft composition shown in Table 2, that is, a mixture containing MMA, BA, and MA, which are monomers for graft component, and n-DM, which is a polymerization initiator, each in an amount shown in Table 2, was continuously added over 2 hours. After the addition of the mixture was finished, the mixture was maintained for 1 hour. Thereby, latex of the corresponding three-layer rubber-containing acrylic graft copolymer (each of A1-5 to A1-8) was obtained. The polymerization conversion was 99% in every case. The latexes of the obtained three-layer rubber-containing acrylic graft copolymers A1-5 to A1-8 were subjected to curing salting, heat-treatment, and drying of known methods, and thereby rubber-containing acrylic graft copolymers A1-5 to A1-8 were obtained as white powders.

TABLE 2

| | | A1-5 | A1-6 | A1-7 | A1-8 |
|---|---|---|---|---|---|
| Monomers for | BA | | 1.25 | 10.5 | 6.3 |
| innermost layer polymer | ST | | | 1.75 | 1.05 |
| | MMA | 24.75 | 23.5 | 12.5 | 7.5 |
| | ALMA | 0.25 | 0.25 | 0.25 | 0.15 |
| Monomers for | BA | 41.5 | 41.5 | 41.5 | 46.2 |
| rubber copolymer | ST | 8 | 8 | 8 | 2.25 |
| | ALMA | 0.5 | 0.5 | 0.5 | 0.55 |
| Average particle | (nm) | 230 | 220 | 210 | 200 |
| diameter of bilayer | | | | | |
| polymer particles | | | | | |
| Graft composition | MMA | 24 | 22.5 | 22.5 | 27 |
| | BA | 1 | 2.5 | | |
| | MA | | | 2.5 | 3 |
| | n-DM | | | | 0.05 |

(unit: parts by weight)

### Production of Carbon Black Masterbatch

In order to improve dispersibility of the carbon black, carbon black (#2600 from Mitsubishi Chemical Corporation) with an average primary particle diameter of 13 nm (according to catalog, 40 parts by weight), acrylic plastic resin (copolymer obtained from 87% by weight of methyl methacrylate and 13% by weight of methyl acrylate, with a melt flow rate of 15 g/10 min (JIS K 7210, 230° C., 37.3 N), 60 parts by weight), and an antioxidant (IRGANOX 1010 from BASF, 0.5 parts by weight) were pelletized twice at 240° C. using a 44-mm twin screw extruder and then pulverized. Thereby, a masterbatch (CB-1) of the carbon black was produced.

For the purpose of comparison, a masterbatch (CB-2) of carbon black with an average primary particle diameter of 50 nm (#20, Mitsubishi Chemical Corporation) was prepared in the same manner.

### Experimental Examples 1 to 13

The following resins were used as the acrylic resin (A2).

A2-1: copolymer of monomers for an acrylic resin including methyl methacrylate (97% by weight) and methyl acrylate (3% by weight), with a melt flow rate of 2.0 g/10 min (JIS K 7210, 230° C., 37.3 N)

A2-2: copolymer of monomers for an acrylic resin including methyl methacrylate (87% by weight) and methyl acrylate (13% by weight), with a melt flow rate of 15 g/10 min (JIS K 7210, 230° C., 37.3 N)

The acrylic resin (A) including the rubber-containing acrylic graft copolymer (A1) and the acrylic resin (A2) and the carbon black masterbatch, each in an amount (parts by weight) shown in Table 3, were mixed. Further, a benzotriazole ultraviolet absorber TINUVIN 234 (registered trademark) (0.5 parts by weight) from BASF, a hindered amine light stabilizer ADK STAB LA-63 (registered trademark) (0.5 parts by weight) from ADEKA CORPORATION, and a hindered phenol antioxidant IRGANOX 1010 (registered trademark) (0.5 parts by weight) from BASF were added to prepare a blend. The blend was pelletized at 240° C. using a 44-mm twin screw extruder. This pellet was formed into a 150 mm×150 mm×3 mm plate and a bar. In Experimental Example 13, the carbon black masterbatch was not used. Instead, a Nigrosine dye (NIGROSINE BASE EX, Orient Chemical Industries Co., Ltd.) was used without preparing a masterbatch.

### <Evaluation>

### (Izod Impact Strength Test)

The bar sample thereby obtained was subjected to the Izod impact strength test under the conditions of: ¼ inch, without notch, and 23° C., in conformity with ASTM D 256. Table 3 shows the measurement results.

### (Jet-Blackness)

The degree of jet-blackness was visually observed using the plate sample. Table 3 shows the evaluation results with the symbols ++: very good, +: good, and −: poor (blurred black).

### (Total Light Transmittance)

Except that the carbon black masterbatch was not mixed, a sample formed into a 150 mm×150 mm×3 mm plate was prepared in the same manner. The total light transmittance of the plate sample was measured in conformity with JIS K 7361-1, and the transparency was evaluated based on the average transmittance value of the 3-mm-thick molded product within a wavelength range of 380 to 780 nm.

### (Weather Resistance)

The weather resistance was evaluated as follows. A 150 mm×150 mm×3 mm plate sample was cut into a size of 47 mm×72 mm×3 mm. The sample was subjected to a weather resistance test performed for 2,000 hours using a sunshine carbon arc lamp weather resistance tester (type: WEL-SUN-HCH•B, sunshine super long life weatherometer, Suga Test Instruments Co., Ltd.) under the conditions of: black panel temperature of 63° C. and a cycle that water was sprayed for 12 minutes within 60-minute irradiation. The degree of jet-blackness after the weather resistance test was visually evaluated in the same manner as in the evaluation of the initial degree of jet-blackness. Table 3 shows the evaluation results. Here, “between ++ and +” means between very good and good.

### (Water Resistance)

The water resistance was evaluated as follows. The 150 mm×150 mm×3 mm plate sample was cut into a size of 47 mm×72 mm×3 mm. The sample was subjected to a water resistance test in which the sample was immersed in 80° C. pure water for 100 hours. The degree of jet-blackness after the water resistance test was visually evaluated in the same manner as in the evaluation of the initial degree of jet-blackness.

Table 3 shows the compositions in Experimental Examples and the evaluation results.

TABLE 3

| | | Experimental | Experimental | Experimental | Experimental | Experimental | Experimental | Experimental |
|---|---|---|---|---|---|---|---|---|
| | | Example 1 | Example 2 | Example 3 | Example 4 | Example 5 | Example 6 | Example 7 |
| Rubber- | A1-1 | 20 | | | | | | |
| containing | A1-2 | | 20 | | | | | |
| acrylic graft | A1-3 | | | 30 | | | | |
| copolymer | A1-4 | | | | | | | |
| (A1) | A1-5 | | | | 20 | | | |
| | A1-6 | | | | | 20 | | |
| | A1-7 | | | | | | 20 | |
| | A1-8 | | | | | | | 20 |
| Acrylic resin | A2-1 | 50 | 50 | 44 | 50 | 50 | 50 | 50 |
| (A2) | A2-2 | 30 | 30 | 26 | 30 | 30 | 30 | 30 |
| Carbon black | CB-1 | 0.5 | 0.5 | 0.5 | 0.5 | 0.5 | 0.5 | 0.5 |
| masterbatch | CB-2 | | | | | | | |
| Nigrosine dye | | | | | | | | |
| Transmittance | % | 90 | 91 | 91 | 90 | 91 | 92 | 91 |
| Degree of jet- | | ++ | ++ | ++ | ++ | ++ | ++ | ++ |
| blackness | | | | | | | | |
| Izod without | J/m | 570 | 550 | 560 | 509 | 527 | 530 | 545 |
| notch | | | | | | | | |
| Dispersion | nm | 30 | 30 | 30 | 30 | 30 | 30 | 30 |
| particle | | | | | | | | |
| diameter of | | | | | | | | |
| carbon black | | | | | | | | |

| | | | | | | | |
|---|---|---|---|---|---|---|---|
| Weather resistance | between | between | between | between | between | between | between |
| | ++ and + | ++ and + | ++ and + | ++ and + | ++ and + | ++ and + | ++ and + |
| Water resistance | ++ | ++ | ++ | ++ | ++ | ++ | ++ |

| | | Experimental | Experimental | Experimental | Experimental | Experimental | Experimental |
|---|---|---|---|---|---|---|---|
| | | Example 8 | Example 9 | Example 10 | Example 11 | Example 12 | Example 13 |
| Rubber- | A1-1 | | | | | | |
| containing | A1-2 | | | | | | |
| acrylic graft | A1-3 | | | | | | |
| copolymer | A1-4 | | | 20 | | | |
| (A1) | A1-5 | | | | | | |
| | A1-6 | 15 | 40 | | 20 | | 20 |
| | A1-7 | | | | | | |
| | A1-8 | | | | | | |
| Acrylic resin | A2-1 | 50 | 10 | 50 | 50 | 62.5 | 50 |
| (A2) | A2-2 | 35 | 50 | 30 | 30 | 37.5 | 30 |
| Carbon black | CB-1 | 0.5 | 0.5 | 0.5 | | 0.5 | |
| masterbatch | CB-2 | | | | 5 | | |
| Nigrosine dye | | | | | | | 0.2 |
| Transmittance | % | 92 | 88 | 60 | 91 | 93 | 90 |
| Degree of jet- | | ++ | ++ | − | − | ++ | ++ |
| blackness | | | | | | | |
| Izod without | J/m | 420 | 984 | 535 | 510 | 190 | 525 |
| notch | | | | | | | |
| Dispersion | nm | 30 | 30 | 30 | 90 | 30 | — |
| particle | | | | | | | |
| diameter of | | | | | | | |
| carbon black | | | | | | | |

| | | | | | | |
|---|---|---|---|---|---|---|
| Weather resistance | between | between | − | − | between | − (color |
| | ++ and + | ++ and + | | | ++ and + | changed) |
| Water resistance | ++ | ++ | − | − | ++ | − (whitened) |

As shown in Table 3, the resin composition of the present invention is excellent in jet-blackness, impact resistance, weather resistance, and moisture resistance (water resistance).

### Experimental Examples 14 to 25

Blending in accordance with the composition (parts by weight) shown in Table 4, extrusion with a single screw extruder, molding, and evaluation were performed. In Experimental Example 25, a C pillar (black mirror-polished surface), which is an exterior component, of a sport-utility vehicle (SUV) produced by a Japanese company was used for the measurement.

### <Materials>

The following resins were used.

Acrylic resin 1: ACRYPET VH001 (Catalog spec: deflection temperature under load (JIS K 7191, 1.80 MPa) of 100° C., Melt flow rate (JIS K 7210, 230° C., 37.3 N) of 2.0 g/10 min) from MITSUBISHI RAYON CO., LTD.

Acrylic resin 2: PARAPET F1000 from KURARAY CO., LTD.

Acrylic resin 3: DELPET 80NE (Catalog spec: deflection temperature under load (15075-1, 75-2) of 97° C., Melt flow rate (ISO1133 cond13) of 2.3 g/10 min) from Asahi Kasei Chemicals Corporation

Acrylic resin 4: DELPET 720V (Catalog spec: deflection temperature under load (15075-1, 75-2) of 93° C., Melt flow rate (ISO1133 cond13) of 21 g/10 min) from Asahi Kasei Chemicals Corporation

Acrylic rubber 1: Kane Ace M210 (acrylic modifier, rubber particles having multilayer structure, core: multilayer acrylic rubber, shell: acrylic polymers mainly containing methyl methacrylate, approximate particle diameter: 220 nm) from Kaneka Corporation

The following was used as carbon black.

A carbon black (40 parts by weight) having an average primary particle diameter of 13 nm, Acrylic resin 2 (59 parts by weight), an antioxidant (IRGANOX 1010, 0.5 parts by weight) and a dispersant (alkyl acid ester, 0.5 parts by weight) were pelletized twice at 260° C. using a 44-mm twin screw extruder, and then pulverized. In this manner, a masterbatch (CB-3) of carbon black was produced.

For comparison, SPAB-8K500 (a masterbatch with carbon concentration of 45%, SUMIKA COLOR CO., LTD.) was used.

In addition to those listed in the blending list, TINUVIN 234 (BASF, benzotriazole ultraviolet absorber), ADK STAB LA-63 (ADEKA CORPORATION, hindered amine light stabilizer), and IRGANOX 1010 (BASF, hindered phenol antioxidant) were used each in an amount of 0.5 parts by weight.

In Experimental Examples 20 to 22 and 24, 2,2′-methylene bis(4,6-di-tert-butylphenyl)octylphosphite (0.3 parts by weight) was blended as a phosphoric stabilizer.

### (Single Screw Extrusion)

A dry-blended mass of the components such as a resin material was extruded with a 40-mm single screw extruder at a die head temperature of 260° C. to provide a strand, and the strand was pelletized using a pelletizer.

### (Injection Molding)

The pellet was molded into a 150 mm×150 mm×3 mm plate (mirror-polished) using an injection molding machine FANUC AUTOSHOT FAS-150B (clamping force: 150 ton) at a nozzle tip temperature of 250° C.

The pellet was molded into a 50 mm×80 mm×2 mm color plate (mirror-polished) using an injection molding machine FN-1000 (Nissei Plastic Industrial Co., Ltd., clamping force: 80 ton) at a nozzle tip temperature of 250° C.

The pellet was molded into an ASTM-standard bar dumbbell using an injection molding machine IS-75E (TOSHIBA CORPORATION, clamping force: 75 ton) at a nozzle tip temperature of 250° C.

### <Evaluation>

Table 4 shows the results of Experimental Examples.

### (Total Light Transmittance)

The total light transmittance was measured using NDH-300A (NIPPON DENSHOKU INDUSTRIES CO., LTD.) in conformity with JIS K 7105.

### (Jet-Blackness)

The degree of jet-blackness was visually observed using the plate sample. The evaluation results were shown with the symbols ++: very good, +: good, and −: poor (blurred black).

### (Lab)

A color difference meter SE2000 (NIPPON DENSHOKU INDUSTRIES CO., LTD., in conformity with JIS Z 8722, 0° to 45° spectroscopy, reflection mode, twice on average, opening attachment φ30) was used as a color difference meter.

The Lab values were measured using the mirror-polished surfaces of the plate and of the color-plate molded product.

### (Weather Resistance)

The weather resistance test was performed for 1,000 hours under the conditions of black panel temperature 63° C., with rain, and an irradiation energy of 255 W/m², in conformity with JIS K 7350-4.

### (Izod Impact Strength Test)

The Izod impact strength test (unit: J/m) was performed using the bar sample under the conditions of: ¼ inch, with notch, and 23° C., in conformity with ASTM D 256.

### (HDT Test)

The HDT test (unit: ° C.) was performed using the bar sample at 0.45 MPa in conformity with ASTM D 648.

### (MFR Test)

The MFR test (unit: g/10 min) was performed using the pellet before molding under the conditions of 230° C. and 5 kgf in conformity with ASTM D 1238.

TABLE 4

| | | Experimental | Experimental | Experimental | Experimental | Experimental | Experimental |
|---|---|---|---|---|---|---|---|
| | | Example 14 | Example 15 | Example 16 | Example 17 | Example 18 | Example 19 |
| Graft copolymer | Acrylic rubber 1 | 15 | 15 | 15 | 15 | 10 | 10 |
| Acrylic resin | Acrylic resin 1 | 50 | 25 | 12.5 | | 70 | 60 |
| | Acrylic resin 2 | 35 | 60 | 72.5 | 85 | 20 | 30 |
| | Acrylic resin 3 | | | | | | |
| | Acrylic resin 4 | | | | | | |
| Carbon black | CB-3 (40%) | 0.5 | 0.5 | 0.5 | 0.5 | 0.5 | 0.5 |
| | SPAB-8K500 | | | | | | |
| Degree of jet-blackness by | | ++ | ++ | ++ | ++ | ++ | ++ |
| visual observation | | | | | | | |
| Plate | L | 5.20 | 5.29 | 5.10 | 5.00 | 5.10 | 5.10 |
| Lab | a | 0.18 | 0.18 | 0.18 | −0.19 | −0.17 | 0.18 |
| Before weather resistance | b | −1.26 | −1.22 | −1.31 | −1.12 | −0.96 | 1.42 |
| Plate | L | 5.57 | 5.57 | 5.57 | 5.48 | 5.48 | 5.48 |
| Weather resistance test | a | 0.19 | −0.13 | 0.19 | −0.14 | 0.19 | 0.19 |
| 1000 h | b | −1.42 | −1.53 | −1.53 | −1.35 | −1.46 | −1.57 |
| Color plate | L | 5.92 | 5.74 | | | | |
| Lab | a | −0.10 | −0.11 | | | | |
| Before weather resistance | b | −1.16 | −1.13 | | | | |
| Color plate | L | 6.00 | 5.92 | | | | |
| Weather resistance test | a | 0.21 | −0.10 | | | | |
| 1000 h | b | −1.36 | −1.36 | | | | |
| IZOD | J/m | 32 | 32 | 31 | 27 | 24 | 24 |
| HDT | ° C. | 101 | 99 | 100 | 99 | 103 | 102 |
| MFR | g/10 min | 3 | 5 | 7 | 9 | 3 | 3 |
| | | Experimental | Experimental | Experimental | Experimental | Experimental | Experimental |
| | | Example 20 | Example 21 | Example 22 | Example 23 | Example 24 | Example 25 |
| Graft copolymer | Acrylic rubber 1 | 15 | 15 | 0 | 20 | 15 | |
| Acrylic resin | Acrylic resin 1 | | | | 80 | | |
| | Acrylic resin 2 | | | | | | |
| | Acrylic resin 3 | 50 | 50 | 60 | | 50 | |
| | Acrylic resin 4 | 35 | 35 | 40 | | 35 | |
| Carbon black | CB-3 (40%) | 0.5 | 2.5 | 0.5 | | | |
| | SPAB-8K500 | | | | 2.22 | 0.5 | |
| Degree of jet-blackness by | | ++ | + | + | − | − | |
| visual observation | | | | | | | |
| Plate | L | 5.57 | 5.92 | 6.00 | 8.77 | 8.25 | 7.68 |
| Lab | a | 0.19 | 0.10 | −0.39 | −0.31 | −0.15 | 0.03 |
| Before weather resistance | b | −1.42 | −1.36 | −1.13 | −1.28 | −1.62 | −0.48 |
| Plate | L | 5.74 | 6.08 | | 8.83 | 8.25 | 7.87 |
| Weather resistance test | a | −0.11 | −0.08 | | −0.30 | 0.07 | −0.18 |
| 1000 h | b | −1.44 | −1.39 | | −1.33 | −1.69 | −1.18 |
| Color plate | L | 6.00 | 6.48 | | 9.85 | 9.43 | |
| Lab | a | 0.21 | −0.05 | | −0.20 | −0.24 | |
| Before weather resistance | b | −0.33 | −1.40 | | −1.40 | −1.49 | |
| Color plate | L | 6.24 | 6.56 | | 9.59 | 9.33 | |
| Weather resistance test | a | −0.07 | −0.05 | | −0.23 | −0.25 | |
| 1000 h | b | −1.51 | −1.46 | | −1.50 | −1.47 | |
| IZOD | J/m | 26 | 26 | 14 | 39 | 26 | |
| HDT | ° C. | 101 | 100 | 106 | 103 | 101 | |
| MFR | g/10 min | 6 | 5 | 8 | 2 | 4 | |

As shown in Experimental Examples 14 to 22 in Table 4, in the comparison of the plates, the L values of the resin molded product of the present invention are within the range of about 5.0 to about 6.0, and are significantly lower than the L values shown in Experimental Examples 23 and 24 (within the range of about 8.2 to about 8.8). Therefore, the resin molded product of the present invention can be considered to have high jet-blackness.

Similarly, in the comparison of the color plates, the L values in Experimental Examples 14 to 22 in Table 4 are within the range of about 5.7 to about 6.5, and are significantly lower than the L values in Experimental Examples 23 and 24 (within the range of about 9.4 to about 9.9). Therefore, the resin molded product of the present invention can be considered to have high jet-blackness. Higher L values of the color plates than the L values of the plates on the whole are probably due to resin orientation on the surface.

The L values in the Experimental Examples 14 to 22 are lower than the L value in Experimental Example 25 (about 7.7), and thus these resin molded products can be considered to have high jet-blackness.

As mentioned above, even though the initial L value is low, the difference between the L values before and after the 1,000-hour weather resistance test is 1 or smaller in Experimental Examples 14 to 21. Therefore, the resin molded product of the present invention is found to be excellent not only in a degree of jet-blackness but also in weather resistance.

### Experimental Examples 26 to 31

Blending in accordance with the composition (parts by weight) shown in Table 5, extrusion using a twin screw extruder, molding, and evaluation were performed. The evaluation was performed in the same manner as in Experimental Examples 14 to 25. Table 5 shows the results.

### (Twin Screw Extrusion)

The blended mass was pelletized using a 44-mm twin screw extruder JSW-TEX44 at a die head temperature of 260° C. in the same manner as in the case of single screw extrusion.

In Experimental Example 31, an A pillar (black mirror-polished surface), which is an exterior component, of a small automobile produced by a German company was used for the measurement. Further, the A pillar was shaved off and a small amount of the shaved matter was immersed in methanol, resulting in that a red to purple colored component was extracted. Thus, the pillar was found to be colored by a dye. The IR spectrum of this methanol-soluble component well corresponded to the IR spectrum of an anthraquinone-based dye. In addition, a small amount of this shaved matter was dissolved in THF, and the soluble component was casted on a KBr plate. The IR spectrum measured in this case well corresponded to the IR spectrum of PMMA resin. Observation of this matter using a TEM (transmission electron microscope) showed that no rubber particles such as acrylic rubber components existed.

TABLE 5

| | | Experimental | Experimental | Experimental | Experimental | Experimental | Experimental |
|---|---|---|---|---|---|---|---|
| | | Example 26 | Example 27 | Example 28 | Example 29 | Example 30 | Example 31 |
| Graft copolymer | Acrylic rubber 1 | 15 | 15 | 30 | 40 | 40 | |
| Acrylic resin | Acrylic resin 3 | 50 | 0 | 20 | 10 | 0 | |
| | Acrylic resin 4 | 35 | 85 | 50 | 50 | 60 | |
| Carbon black | CB-3 (40%) | 0.5 | 0.5 | 0.5 | 0.5 | 0.5 | |
| Degree of jet-blackness by | | ++ | ++ | ++ | + | + | ++ |
| visual observation | | | | | | | |
| Plate | L | 5.66 | 5.29 | 5.66 | 5.74 | 5.74 | 4.24 |
| Lab | a | −0.12 | 0.18 | −0.12 | −0.11 | −0.11 | 0.15 |
| Before weather resistance test | b | −1.06 | −1.11 | −1.27 | −1.34 | −1.34 | −1.08 |
| Plate | L | 5.74 | 5.57 | 5.83 | 6.00 | 5.92 | 5.39 |
| Weather resistance test | a | 0.20 | −0.13 | −0.11 | −0.09 | 0.20 | 0.52 |
| 1000 h | b | −1.34 | −1.21 | −1.30 | −1.52 | −1.36 | −1.84 |
| Color plate | L | 6.40 | 5.92 | 6.63 | 7.14 | 7.28 | |
| Lab | a | −0.34 | −0.10 | −0.04 | 0.00 | 0.01 | |
| Before weather resistance test | b | −1.16 | −1.06 | −1.43 | −1.72 | −1.74 | |
| Color plate | L | 6.32 | 5.92 | 6.24 | 6.40 | 6.48 | |
| Weather resistance test | a | −0.06 | 0.20 | 0.21 | −0.06 | 0.22 | |
| 1000 h | b | −1.38 | −1.36 | −1.32 | −1.34 | −1.31 | |
| IZOD | J/m | 25 | 25 | 47 | 61 | 63 | |
| HDT | ° C. | 102 | 100 | 99 | 98 | 96 | |
| MFR | g/10 min | 6 | 19 | 6 | 4 | 6 | |

With respect to the plates, as shown in Experimental Examples 26 to 30 in Table 5, the L values of the resin compositions of the present invention are within the range of about 5.2 to about 5.8. With respect to the color plates, the L values are within the range of about 5.9 to about 7.3. Therefore, the resin molded product of the present invention is considered to have high jet-blackness regardless of the melt kneading methods.

As mentioned above, the difference between the L values before and after the 1,000-hour weather resistance test is 1 or smaller even though the initial L value is low in each of Experimental Examples 26 to 30. Therefore, the resin molded product of the present invention is found to be excellent not only in a degree of jet-blackness but also in weather resistance. In contrast, in Experimental Example 31, the difference between the L values before and after the 1,000-hour weather resistance test is greater than 1 even though the initial L value is low. Therefore, the weather resistance is poor.

The following materials and methods were used to produce samples in Experimental Examples 32 to 40 and various evaluations of the samples were carried out. Tables 6 to 8 show compositions and evaluation results.

### <Material>

### (Rubber-Containing Acrylic Graft Copolymer (A1))

Kane Ace M210 (acrylic modifier, rubber particles having multilayer structure, core: multilayer acrylic rubber, shell: acrylic polymers mainly containing methyl methacrylate, approximate particle diameter 220 nm) from Kaneka Corporation

### (Acrylic Resin (A2))

Acrylic resin 1: ACRYPET VH001 (Catalog spec: deflection temperature under load (JIS K 7191, 1.80 MPa) of 100° C., Melt flow rate (JIS K 7210, 230° C., 37.3 N) of 2.0 g/10 min) (total light transmittance of 3 mm-thick molded product: 92.5%) from MITSUBISHI RAYON CO., LTD.

Acrylic resin 2: PARAPET F1000 (total light transmittance of 3 mm-thick molded product: 92.5%) from KURARAY CO., LTD.

Acrylic resin 3: DELPET 80NE (Catalog spec: deflection temperature under load (ISO75-1, 75-2) of 97° C., Melt flow rate (ISO1133 cond13) of 2.3 g/10 min) (total light transmittance of 3 mm-thick molded product: 92%) from Asahi Kasei Chemicals Corporation

Acrylic resin 4: DELPET 720V (Catalog spec: deflection temperature under load (ISO75-1, 75-2) of 93° C., Melt flow rate (ISO1133 cond13) of 21 g/10 min) (total light transmittance of 3 mm-thick molded product: 92%) from Asahi Kasei Chemicals Corporation

### (Carbon Black Masterbatch)

A carbon black (#2600 from Mitsubishi Chemical Corporation, actual particle diameter measured with a TEM: 10 nm, 40 parts by weight), Acrylic resin 2 (59 parts by weight), an antioxidant (IRGANOX 1010 from BASF, 0.5 parts by weight), and a dispersant (0.5 parts by weight) were pelletized twice at 260° C. (a mixture of the carbon black and the acrylic resin was pelletized first, and the resulting pellet and other components were mixed and pelletized) using a 44-mm twin screw extruder. The resulting pellet was pulverized to give a masterbatch (CB-4) of carbon black. A resin composition was prepared using the masterbatch, not a carbon black itself.

### (Phosphorus Stabilizer)

PEP-36 (bis(2,6-di-t-butyl-4-methylphenyl)pentaerythritol diphosphite) from ADEKA CORPORATION

HP-10 (2,2′-methylene bis(4,6-di-tert-butylphenyl)octylphosphite) from ADEKA CORPORATION

### (Other Compounding Agent)

In addition to the components shown in Tables, TINUVIN 234 (benzotriazole ultraviolet absorber) from BASF, ADK STAB LA-63 (hindered amine light stabilizer) from ADEKA CORPORATION, and IRGANOX 1010 (hindered phenol antioxidant) from BASF were used each in an amount of 0.5 parts by weight.

### <Method>

### (Single Screw Extrusion)

A 40-mm single screw extruder (ISHINAKA IRON WORKS, CO., LTD.) was used to extrude the composition prepared by dry-blending the above materials at a die head temperature of 260° C. The resulting strand was pelletized with a pelletizer.

### (Twin Screw Extrusion)

A 44-mm twin screw extruder JSW-TEX44 (The Japan Steel Works, LTD.) was similarly used for pelletization at a die head temperature of 260° C.

### (Injection Molding)

Samples used in Experimental Examples 32 to 35 were produced as mentioned below. An injection molding machine of FANUC AUTOSHOT FAS-150B (clamp force of 150 t) was used with a nozzle tip set at predetermined temperatures to mold a large plate sample (mirror-polished surface) in a size of 150 mm×150 mm×3 mm.

In production of samples for boss strength evaluation used in Experimental Examples 36 to 40, an injection molding machine of FANUC AUTOSHOT FAS-150B (clamp force of 150 t) was used with a nozzle tip set at 250° C. The produced molded products for M5 boss strength evaluation were in a circular shape (diameter: 160 mm, thickness: 2.5 mm) with plural boss portions along its circumference.

### Experimental Examples 32 to 35

Blending in accordance with the composition shown in Table 6, extrusion with an extruder, molding, and evaluation were performed.

TABLE 6

| | | Experimental | Experimental | Experimental | Experimental |
|---|---|---|---|---|---|
| | | Example 32 | Example 33 | Example 34 | Example 35 |
| Extruder | | Single screw | Single screw | Single screw | Resin only |
| A1 (parts by weight) | | 15 | 15 | 15 | |
| A2 (parts by weight) | Acrylic resin 1 | 50 | 50 | 50 | 100 |
| | Acrylic resin 2 | 35 | 35 | 35 | |
| Phosphorus stabilizer | PEP-36 | | 0.3 | | |
| (parts by weight) | HP-10 | | | 0.3 | |
| Carbon black (parts by weight) | CB-4 (40% by weight) | 0.5 | 0.5 | 0.5 | |

### <Evaluation>

### (Thermal Stability in Residence)

Thermal stability in residence during injection molding was evaluated. In the case of no residence time, cooling time was set to 18 seconds (standard cooling time). Cycle time in that case was 37 seconds (standard cycle time). In evaluation, the cooling time was prolonged by the length of the set residence time. For example, in the case of residence time of 60 seconds, the cooling time was set to 78 seconds (standard cooling time+residence time) and the cycle time was 97 seconds (standard cycle time+residence time). The residence time was prolonged after every two injection molding. Namely, at each temperature, after two shots were molded with no residence time, two shots were molded with residence time of 60 seconds. Then, two shots were molded with residence time of 120 seconds, and two shots were molded with residence time of 180 seconds. When the molding temperature was changed, the cylinder was completely purged.

The resulting molded products were visually observed for assessment of the state of flash (patterns of plural lines, silver streak), and evaluated based on the following criteria.

Good: No flash was observed and a clear mirror surface was obtained.
Fair: Fine flash was observed.
Poor: Obvious flash was observed.
Failure: Resin started foaming during purging of cylinder and molding could not be performed.
−: Molding was not performed.

TABLE 7

| Nozzle tip temperature | Residence time | Experimental | Experimental | Experimental | Experimental |
|---|---|---|---|---|---|
| (° C.) | (seconds) | Example 32 | Example 33 | Example 34 | Example 35 |
| 250 | 0 | Good | Good | Good | Good |
| 270 | 0 | Failure | Good | Good | Good |
| | 60 | — | Good | Good | Good |
| | 120 | — | Good | Good | Good |
| | 180 | — | Good | Good | Poor |
| 290 | 0 | — | Good | Good | Failure |
| | 60 | — | Fair | Good | — |
| | 120 | — | Fair | Good | — |
| | 180 | — | Poor | Good | — |

In the case where an organophosphorus stabilizer was added, high thermal stability in residence was observed. Especially, it was found out that a composition containing 2,2′-methylene bis(4,6-di-tert-butylphenyl)octylphosphite can bear long residence for three minutes even at a molding temperature as high as 290° C. One reason for this is that the melting point of the organophosphorus stabilizer is within a range that matches the processing temperature range of the acrylic resin, that is, there is a sufficient temperature difference between the melting point of the stabilizer and the processing temperature of the resin. Namely, in both extrusion kneading and injection molding, the phosphorus stabilizer needs to sufficiently melt at the processing temperature to be well blended in the composition. From this viewpoint, if the melting point of the phosphorus stabilizer is too high relative to the processing temperature, the phosphorus stabilizer does not sufficiently melt at the processing temperature and fails to exhibit its function. On the other hand, if the melting point of the phosphorus stabilizer is too low, though it has no problem in melting, defects such as bleed out may be caused in use of the resulting molded product.

### Experimental Examples 36 to 40

Blending in accordance with the composition shown in Table 8, extrusion with an extruder, molding, and evaluation were performed. In Experimental Examples 39 and 40, the acrylic resin (raw material) was molded as it was.

### <Evaluation>

### (Boss Strength)

Evaluation of boss strength (M5): Into each of Boss 1 (outer diameter of 8.0 mm, inner diameter of 4.5 mm, depth of 10 mm) and Boss 2 (outer diameter of 10.0 mm, inner diameter of 4.3 mm, depth of 10 mm), a pan head tapping screw (M5.0×6 mm) was screwed twice. Presence of cracks in the bosses was visually observed. Conditions for screwing and evaluation results are shown below.

Torque: 3N·m

Rotation: 1000 rpm

Number of samples: 3

Good: No crack and no abnormality such as idling

Poor: Broken or significant cracks

TABLE 8

| | | Experimental | Experimental | Experimental | Experimental | Experimental |
|---|---|---|---|---|---|---|
| | | Example 36 | Example 37 | Example 38 | Example 39 | Example 40 |
| Extruder | | Twin screw | Single screw | Twin screw | | |
| A1 (parts by weight) | | 15 | 40 | 40 | | |
| A2 (parts by weight) | Acrylic resin 1 | 50 | | 10 | | |
| | Acrylic resin 2 | 35 | | 50 | | |
| | Acrylic resin 3 | | | | 100 | |
| | Acrylic resin 4 | | 60 | | | 100 |
| Phosphorus stabilizer | HP-10 | | 0.3 | | | |
| (parts by weight) | | | | | | |
| Carbon black | CB-4 | 0.5 | 0.5 | 1.0 | | |
| (parts by weight) | (40% by weight) | | | | | |

| | | | | | |
|---|---|---|---|---|---|
| Evaluation result | Good | Good | Good | Poor | Poor |

As shown above, it was found that the molded product produced from the composition of the present invention has excellent practical strength.

### (Large Molding)

Assuming a B-pillar of an automobile, a plate in a size of 600 mm×100 mm×10 mm (3 mm thick) having a substantially “U” shape in cross section was molded from the resin composition of Experimental Example 36 by using a 360-t injection molding machine (Nissei Plastic Industrial Co., Ltd.) at 280° C. The obtained product was a favorable jet-black molded product.

### (TEM Observation)

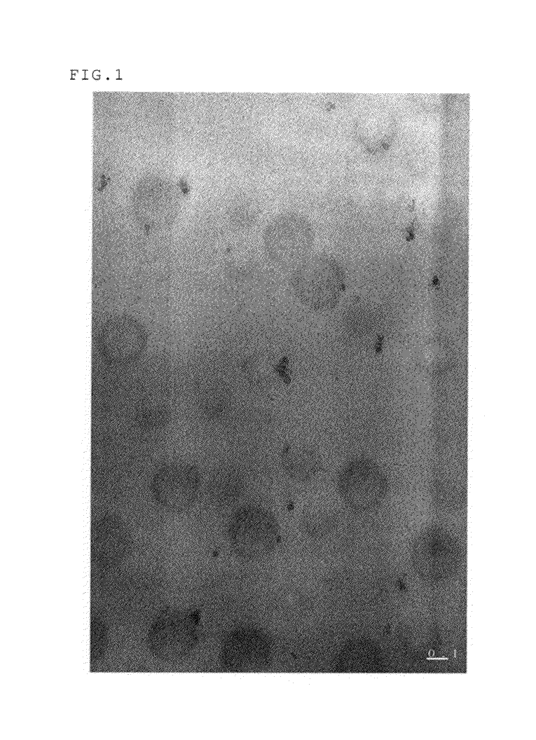

An ultrathin section cut out from the molded product of Experimental Example 36 with a microtome was subjected to ruthenium staining and then observed using a TEM (transmission electron microscope). As shown in FIG. 1, a fine carbon black is favorably dispersed in the resin. Carbon black particles seem to link each other because particles in front overlap with particles in the back. Use of a fine carbon black and favorable dispersion of the carbon black without aggregation are obviously required to achieve jet-blackness. A resin molded product and an automobile component produced from such a resin composition each have excellent appearance.

### Experimental Examples 41 to 47

The following materials and methods were used to produce samples. The samples were each subjected to various evaluations.

### <Materials>

### (Rubber-Containing Acrylic Graft Copolymer (A1))

Kane Ace M210 from Kaneka Corporation

### (Acrylic Resin (A2))

DELPET 80NE from Asahi Kasei Chemicals Corporation

DELPET 720V from Asahi Kasei Chemicals Corporation

### (Lubricant)

WAXE: Montanic acid wax (montanic acid ethylene glycol ester) from Clariant

G47: C13-C24 esters of C11-C24 fatty acids, LOXIOL G47 from Emery Oleochemicals Japan

WH255C: higher aliphatic acid amide (Light Amide) from KYOEISHA CHEMICAL Co., LTD.

EB-FF: Ethylene bis stearamide from Kao Corporation

FZ3703: silicone oil from Nippon Unicar Company Limited

### (Carbon Black)

Carbon black (#2600 from Mitsubishi Chemical Corporation, actual particle diameter measured with a TEM: 10 nm)

In order to improve dispersibility of the carbon black, carbon black (40 parts by weight), an acrylic plastic resin (copolymer of 87% by weight of methyl methacrylate and 13% by weight of methyl acrylate with a melt flow rate of 15 g/10 min (JIS K 7210, 230° C., 37.3 N), 60 parts by weight), and an antioxidant (IRGANOX 1010 from BASF, 0.5 parts by weight) were pelletized twice at 240° C. using a 44-mm twin screw extruder, and then pulverized. In this manner, a masterbatch (CB-5) of carbon black was produced.

### <Method>

To Kane Ace M210 (15 parts by weight), DELPET 80NE (50 parts by weight), DELPET 720V (35 parts by weight), the masterbatch (CB-5) (0.5 parts by weight) and a lubricant in an amount shown in Table 9 were added TINUVIN 234 (benzotriazole ultraviolet absorber from BASF, 0.5 parts by weight), ADK STAB LA-63 (hindered amine light stabilizer from ADEKA CORPORATION, 0.5 parts by weight) and IRGANOX 1010 (hindered phenol antioxidant from BASF, 0.5 parts by weight) and dry-blended. The resulting mixture was pelletized using a 44-mm twin screw extruder at 240° C. From the resulting pellet, a plate in a size of 150 mm×150 mm×3 mm, a color plate (CP) in a size of 50 mm×90 mm×3 mm, and a bar in a size of 63.5 mm×12.7 mm×6.3 mm were molded, and evaluation was performed thereon.

### <Evaluation>

### (Measurement of L Value)

The L value that is an index of jet-blackness of each of the plate sample and the color plate sample was measured using SE2000 (0° to 45° spectroscopic color difference meter in conformity with JIS Z 8722) from NIPPON DENSHOKU INDUSTRIES CO., LTD. The L value was determined by irradiating a measurement surface of a resin molded product with light from straight above (90°) and measuring light reflected in a direction of 45° from the measurement surface. The samples for measurement of L values were produced using a die (NAK80 from Daido Steel Co., Ltd. was used as a steel material) which was preliminary mirror-polished with a #7000 compound.

### (Abrasion Resistance Test)

Abrasion resistance of a mirror surface of the molded product sample formed by a die face during injection molding was tested using an abrasion tester under the following conditions.

Equipment: HEIDON abrasion tester 14DR (SHINTO Scientific Co., Ltd.)

Travel speed: 6000 mm/min.

Travel length: 5 cm

Number of travelling: 50 reciprocations

Load: 1 kg

Abrasion jig: An ASTM jig was fixed to an axis so as not to have a partial contact and the jig was set to be always parallel with the sample. A small rigid-plastic plate in a size of 2 cm×2 cm×2 mm was bonded to the lower part of the ASTM jig. A cotton cloth (Kanakin #3) was wound quadruply around the jig with plate and fixed with a stopper of the ASTM jig. The cloth was in contact with the sample in an area of about 4 cm² and the load was correctly applied to the sample. In that state, an abrasion resistance test was carried out.

The samples after test was visually observed and evaluated based on the following criteria.

4: Almost no scratch was observed on the surface

1: Obvious many linear scratches were observed and the sample seen from the front (viewer's head was positioned in the normal direction perpendicular to the plate sample and light from behind was interrupted by the viewer's head) was white.

2: Between 4 and 1. Scratches were visible from the front.

3: Between 4 and 2. Scratches were hardly seen from the front but visible from an oblique direction.

Table 9 shows the kind of the lubricant, composition, L value and the result of the abrasion resistance test in each Experimental Examples.

TABLE 9

| | Experimental | Experimental | Experimental | Experimental | Experimental | Experimental | Experimental |
|---|---|---|---|---|---|---|---|
| | Example 41 | Example 42 | Example 43 | Example 44 | Example 45 | Example 46 | Example 47 |
| Lubricant | WAXE | WAXE | G47 | WH255C | EB-FF | — | FZ3703 |
| Lubricant | Montanic acid | Montanic acid | C13-24 esters | Higher | Ethylene bis | — | Silicone oil |
| material | ethylene | ethylene | of C11-24 | aliphatic acid | stearamide | | |
| | glycol ester | glycol ester | fatty acids | amide | | | |
| Parts by weight | 2 | 1 | 2 | 1 | 2 | 0 | 0.5 |
| L value | 6.32 | 5.92 | 5.92 | 6.48 | 5.83 | 5.74 | 6.86 |
| Abrasion test | 4 | 2 | 3 | 2 | 3~4 | 1 | 1 |

Table 9 indicates that when an ester of C10-C30 fatty acids, especially, montanic acid ethylene glycol ester was used as a lubricant, the L value that is an index of jet-blackness and the abrasion resistance are both favorable and well balanced in the obtained molded product.

Specifically, favorable abrasion resistance was observed in Experimental Example 41 even in an abrasion resistance test under severe conditions of 50 reciprocations under 1 kgf load. In Experimental Example 41, difference in the L value indicating jet-blackness from Experimental Example 46 using no lubricant was surprisingly less than 1. In Experimental Example 42, abrasion resistance was comparatively fine, though not as favorable as in Experimental Example 41. Moreover, difference in the L value indicating jet-blackness from Experimental Example 46 using no lubricant was surprisingly less than 0.3. In Experimental Example 43, the abrasion resistance was better than that in Experimental Example 42 and the jet-blackness was as favorable as that in Experimental Example 42. Accordingly, ester lubricants other than montanic acid esters are also preferable as lubricants. In Experimental Examples 44 and 45, amide lubricants obviously chemically different from ester lubricant used in Experimental Examples 41 to 43 were used. However, jet-blackness and abrasion resistance were equal to those in Experimental Examples 41 to 43. Accordingly, amide lubricants are also preferable. Evaluation result of Experimental Example 45 in the abrasion resistance test was between 3 and 4. This shows that, even with stearamide, the change of L value is small and abrasion resistance is favorable.

In contrast, in Experimental Example 47, jet-blackness was poor and abrasion resistance was not improved. This shows it is important to select a lubricant especially in view of its melting point and polarity.

### Experimental Examples 48 to 56

The following materials and methods were used to produce samples. The samples were each subjected to various evaluations.

### <Materials>

### (Rubber-Containing Acrylic Graft Copolymer (A1))

Kane Ace M210 from Kaneka Corporation

### (Acrylic Resin (A2))

(A2-3): Copolymer of monomers for an acrylic resin including methyl methacrylate (97% by weight) and methyl acrylate (3% by weight) with a melt flow rate of 2.0 g/10 min (JIS K 7210, 230° C., 37.3 N) (total light transmittance of a 3 mm-thick molded product: 92%)

(A2-4): Copolymer of monomers for an acrylic resin including methyl methacrylate (87% by weight) and methyl acrylate (13% by weight) with a melt flow rate of 15 g/10 min (JIS K 7210, 230° C., 37.3 N) (total light transmittance of a 3 mm-thick molded product: 92%) (Composition (CB-7))

In order to improve dispersibility of the carbon black, a carbon black (#2600 from Mitsubishi Chemical Corporation, actual particle diameter measured with a TEM: 10 nm, 40 parts by weight), aforementioned (A2-3) (60 parts by weight), and an antioxidant (IRGANOX 1010 from BASF, 0.5 parts by weight) were pelletized twice at 240° C. using a 44-mm twin screw extruder, and then pulverized to produce a masterbatch (CB-6) of carbon black. The rubber modified acrylic resin (A) including the rubber-containing acrylic graft copolymer (A1) and the acrylic resin (A2) and the masterbatch (CB-6) of carbon black, each in an amount shown in Table 10, were mixed. TINUVIN 234 (benzotriazole ultraviolet absorber from BASF, 0.5 parts by weight), ADK STAB LA-63 (hindered amine light stabilizer from ADEKA CORPORATION, 0.5 parts by weight), and IRGANOX 1010 (hindered phenol antioxidant from BASF, 0.5 parts by weight) were added thereto to prepare a blend. The blend was pelletized at 240° C. using a 44-mm twin screw extruder to produce a composition (CB-7).

### (Composition (CB-8))

For comparison, the rubber modified acrylic resin (A) including the rubber-containing acrylic graft copolymer (A1) and the acrylic resin (A2), and SPAB-8K500 (carbon concentration of 45% by weight) from SUMIKA COLOR CO., LTD. which is a commercially available carbon black masterbatch, each in an amount shown in Table 10, were mixed. TINUVIN 234 (0.5 parts by weight), ADK STAB LA-63 (0.5 parts by weight), and IRGANOX 1010 (0.45 parts by weight) were added thereto to prepare a blend. The blend was pelletized at 240° C. using a 44-mm twin screw extruder to produce a composition (CB-8).

TABLE 10

| | | CB-7 | CB-8 |
|---|---|---|---|
| A1 (parts by weight) | | 15 | 15 |
| A2 (parts by weight) | A2-3 | 50 | 50 |
| | A2-4 | 35 | 35 |
| Carbon black (parts by weight) | CB-6 | 0.5 | 0 |
| | SPAB-8K500 | 0 | 0.45 |

| | | |
|---|---|---|
| Actual carbon concentration (weight ppm) | 1970 | 1990 |

### <Method>

### Experimental Examples 48

To the rubber modified acrylic resin (A) (100 parts by weight) which contains the rubber-containing acrylic graft copolymer (A1) (15 parts by weight) and the acrylic resin (A2) (85 parts by weight) containing aforementioned (A2-3) (50 parts by weight) and (A2-4) (35 parts by weight), TINUVIN 234 (0.5 parts by weight), ADK STAB LA-63 (0.5 parts by weight), and IRGANOX 1010 (0.5 parts by weight) were added. The mixture was dry-blended and pelletized at 240° C. using a 44-mm twin screw extruder. The resulting pellet was formed into a plate in a size of 150 mm×150 mm×3 mm, a color plate in a size of 50 mm×90 mm×3 mm, and a bar in a size of 63.5 mm×12.7 mm×6.3 mm.

### Experimental Examples 49 to 52

Added to the rubber modified acrylic resin composition (101.5 parts by weight) of Experimental Example 48 was the composition (CB-7) in an amount of 2.5 parts by weight in Experimental Example 49, 5 parts by weight in Experimental Example 50, 10 parts by weight in Experimental Example 51, and 20 parts by weight in Experimental Example 52. The resulting compositions were each molded in the same manner as in Experimental Example 48 to obtain a plate, a color plate (CP) and a bar.

### Experimental Examples 53 to 56

Samples of Experimental Examples 53 to 56 were produced and evaluated in the same manner as in Experimental Examples 49 to 52 except that the composition (CB-8) was used instead of the composition (CB-7).

Namely, to the rubber modified acrylic resin composition (101.5 parts by weight) of Experimental Example 48 was added the composition (CB-8) in an amount of 2.5 parts by weight in Experimental Example 53, 5 parts by weight in Experimental Example 54, 10 parts by weight in Experimental Example 55, and 20 parts by weight in Experimental Example 56. The resulting compositions were each molded in the same manner as in Experimental Example 48 to obtain a plate, a color plate, and a bar.

### <Evaluation>

### (Measurement of L Value)

The L value of each of the plate sample and the color plate (CP) sample was measured using SE2000 (0° to 45° spectroscopic color difference meter in conformity with JIS Z 8722) from NIPPON DENSHOKU INDUSTRIES CO., LTD. The L value was determined by irradiating a measurement surface of a resin molded product with light from straight above) (90° and measuring light reflected in a direction of 45° from the measurement surface. The samples for measurement of L values were produced using a die (NAK80 from Daido Steel Co., Ltd. was used as a steel material) which was preliminary mirror-polished with a #7000 compound.

### (Measurement of Total Light Transmittance and Haze)

The total light transmittance and the haze were each an average transmission value of the plate sample in a wavelength of 380 to 780 nm measured using NDH-300A from NIPPON DENSHOKU INDUSTRIES CO., LTD. in conformity with JIS K 7105.

### (Transmittance of Parallel Rays)

Transmittance of parallel rays was calculated based on these measurement results using the following Equation 2.

Transmittance of parallel rays=0.01×total light transmittance×(100−haze) (Equation 2)

### (Absorption Coefficient)

Absorption coefficient (ppm⁻¹cm⁻¹) of each sample was calculated based on the resulting transmittance of parallel rays using the following Equation 1.

Absorption coefficient=[log₁₀(I₀/I)]/(C×L) (Equation 1)

In the Equation 1, “C” indicates carbon black weight concentration (ppm) in the resin, “L” indicates thickness (cm) of each sample in a direction parallel with the measured rays, “I₀” indicates transmittance of parallel rays of the sample of Reference Example 1 not containing a carbon black, “I” indicates transmittance of parallel rays of each sample in which a carbon black is dispersed.

### (Izod Impact Test)

Izod impact test was carried out on the bar samples in conformity with ASTM D256, under the conditions of ¼ inches, without notch, and at 23° C.

### (Carbon Black Number Average Particle Diameter)

An ultrathin section cut out from a plate sample with a microtome was subjected to ruthenium staining and then observed using a TEM (transmission electron microscope). The number average particle diameter (dispersion particle diameter) is determined by observing by TEM the carbon black aggregates dispersed in the molded product and measuring the sizes of the components which cannot be separated any more while maintaining their outlines, and calculating the arithmetic mean of the sizes under the condition of N=50 particles.

### (Initial Opaqueness)

Opaqueness of the plate samples was visually evaluated based on the following criteria.

4: Significantly excellent

3: Inferior to 4 but still significantly excellent

2: Excellent

1: Poor (nonuniform color tone)

### (Weather Resistance)

The weather resistance was evaluated as follows. A 150 mm×150 mm×3 mm plate sample was cut into a size of 47 mm×72 mm×3 mm. The sample was subjected to a weather resistance test performed for 2,000 hours using a sunshine carbon arc lamp weather resistance tester (type: WEL-SUN-HCH•B, sunshine super long life weatherometer, Suga Test Instruments Co., Ltd.) under the conditions of: black panel temperature of 63° C. and a cycle that water was sprayed for 12 minutes within 60-minute irradiation. Those maintaining ΔE of less than 3 were rated excellent in weather resistance.

### (Appearance)

Appearance of the samples was visually observed and evaluated based on the following criteria.

Good: Excellent black appearance

Poor: Not excellent black appearance

Table 11 shows calculated value of carbon concentration, L value, total light transmittance, haze, absorption coefficient, Izod impact strength, carbon black number average particle diameter, weather resistance, and evaluation result of appearance of each sample. As shown in Table 11, the resin molded product of the present invention is excellent in blackness, opaqueness, impact resistance, weather resistance, and appearance.

TABLE 11

| | Experimental | Experimental | Experimental | Experimental | Experimental | Experimental | Experimental | Experimental | Experimental |
|---|---|---|---|---|---|---|---|---|---|
| | Example 48 | Example 49 | Example 50 | Example 51 | Example 52 | Example 53 | Example 54 | Example 55 | Example 56 |
| Carbon | 0 | 48 | 94 | 179 | 329 | 49 | 95 | 181 | 332 |
| concentration | | | | | | | | | |
| (weight ppm) | | | | | | | | | |
| L value (CP) | 11.0 | 6.0 | 5.4 | 5.4 | 5.2 | 7.4 | 7.2 | 7.4 | 7.6 |
| L value (Plate) | 6.7 | 5.7 | 5.0 | 5.0 | 5.2 | 7.0 | 6.9 | 7.1 | 7.3 |
| Total light | 92.5 | 29.60 | 11.50 | 1.90 | 0.10 | 16.68 | 3.46 | 0.18 | 0.00 |
| transmittance | | | | | | | | | |
| (Plate) (T %) | | | | | | | | | |
| Haze (%) | 2.23 | 3.49 | 2.67 | 3.72 | 4.74 | 3.49 | 4.74 | 6.78 | 100.00 |
| Transmittance of | 90.44 | 28.57 | 11.19 | 1.83 | 0.10 | 16.10 | 3.30 | 0.17 | 0.00 |
| parallel rays (%) | | | | | | | | | |
| Absorption | | 0.0348 | 0.0322 | 0.0315 | 0.0302 | 0.0510 | 0.0505 | 0.0503 | |
| coefficient | | | | | | | | | |
| (ppm⁻¹cm⁻¹) | | | | | | | | | |
| Izod strength | 460 | 460 | 460 | 460 | 460 | 460 | 460 | 460 | 460 |
| (J/m) | | | | | | | | | |
| Carbon black | — | 10 | 10 | 10 | 10 | 30 | 30 | 30 | 30 |
| number average | | | | | | | | | |
| particle size | | | | | | | | | |
| (nm) | | | | | | | | | |
| Initial | 3 | 3 | 3 | 3 | 3 | 3 | 3 | 3 | — |
| opaqueness | | | | | | | | | |
| Weather | Excellent | Excellent | Excellent | Excellent | Excellent | Excellent | Excellent | Excellent | Excellent |
| resistance | | | | | | | | | |
| Appearance | — | Good | Good | Good | Good | Poor | Poor | Poor | Poor |

Samples of Experimental Examples 49 to 52 each had excellent black appearance. Samples of Experimental Examples 53 to 56 each had a black appearance lacking in richness and were inferior to the black appearance of the samples of Experimental Examples 49 to 52.

Samples of the compositions (CB-7) and (CB-8) were observed using a TEM.

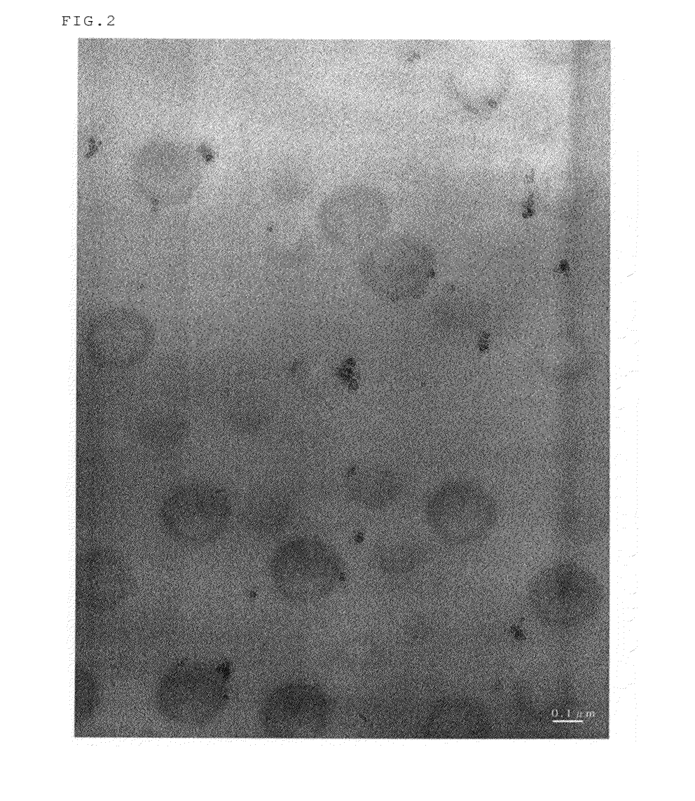

FIG. 2 illustrates a TEM picture of the sample of the composition (CB-7). It shows that primary particles of the carbon black were uniformly dispersed so as to have a number average particle diameter of 10 to 15 nm. Carbon black particles seem to link each other because particles in front overlap with particles in the back. Particles having a particle diameter of 220 nm therein are rubber-containing acrylic graft copolymers (A1).

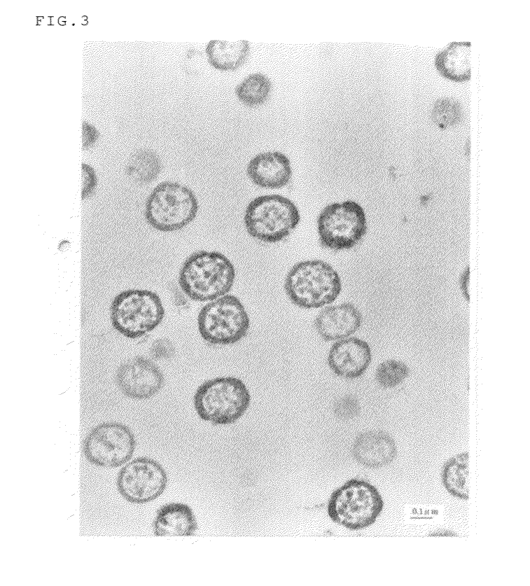

FIG. 3 illustrates a TEM picture of the sample of the composition (CB-8). It shows that multiple particles of carbon black aggregate to form particles having a number average particle diameter of 50 nm and are dispersed in that state. Particles having a particle diameter of 220 nm therein are rubber-containing acrylic graft copolymers (A1).

Table 11 shows that, in Experimental Examples 49 to 52 using the composition (CB-7) wherein the dispersion of the carbon black is primary dispersion and uniform in a state that the number average particle diameter is 10 to 15 nm, the carbon black in the sample has a number average particle diameter of 10 nm and the dispersion thereof is primary dispersion.

The resin molded product of the present invention includes the acrylic resin (A) in which the carbon black (B) is dispersed so as to have a specific absorption coefficient. Accordingly, compared to a conventional carbon black-dispersed resin molded product, the resin molded product of the present invention is a resin molded product with low absorption of light, high light transmittance, excellent blackness and opaqueness with excellent black appearance.

1. A resin composition comprising:
an acrylic resin (A); and
a carbon black (B) having a number average particle diameter of 10 to 40 nm.

2. The resin composition according to claim 1,
wherein the carbon black (B) is dispersed so as to have a number average particle diameter of 10 to 40 nm.

3. The resin composition according to claim 2,
wherein dispersion of the carbon black (b) is primary dispersion and the carbon black (B) is dispersed so as to have a number average particle diameter of 10 to 40 nm.

4. The resin composition according to claim 1,
further comprising an organophosphorus stabilizer having a melting point of 120 to 250° C.

5. The resin composition according to claim 1,
further comprising at least one lubricant selected from the group consisting of esters of C10 to C30 fatty acids and amides of C10 to C30 fatty acids.

6. The resin composition according to claim 1,
wherein a molded product produced from the resin composition has an absorption coefficient of 0.02 to 0.04 ppm⁻¹cm⁻¹.

7. The resin composition according to claim 1,
wherein the acrylic resin (A) provides a 3 mm-thick molded product having a total light transmittance of 85% or more.

8. The resin composition according to claim 1,
wherein the acrylic resin (A) contains a rubber-containing acrylic graft copolymer (A1).

9. The resin composition according to claim 8,
wherein 100 parts by weight of the acrylic resin (A) contains 5 to 100 parts by weight of a rubber-containing acrylic graft copolymer (A1) and 95 to 0 parts by weight of an acrylic resin (A2);
the rubber-containing acrylic graft copolymer (A1) is a multilayer graft copolymer having an inner layer of a rubber copolymer (A1c) and an outer layer of a graft component (A1s) with a weight ratio (A1c:A1s) of 5:95 to 85:15, the outer layer covering the inner layer;
the rubber copolymer (A1c) is a polymer of 100% by weight of monomers for rubber copolymer (A1c) containing 50 to 99.9% by weight of an alkyl acrylate, 0 to 49.9% by weight of another copolymerizable vinyl monomer, and 0.1 to 10% by weight of a polyfunctional monomer;
the graft component (A1s) is a polymer of 100% by weight of monomers for graft component (A1s) containing 50 to 100% by weight of an alkyl methacrylate and 0 to 50% by weight of a copolymerizable vinyl monomer other than the alkyl methacrylate; and
the acrylic resin (A2) is a polymer of monomers for acrylic resin (A2) containing 0 to 50% by weight of an alkyl acrylate and 100 to 50% by weight of an alkyl methacrylate.

10. The resin composition according to claim 9,
wherein the rubber-containing acrylic graft copolymer (A1) is a multilayer graft copolymer which has at least three layers, which further has an innermost layer polymer (A1a) with a weight ratio (A1a:(sum of A1c and A1s)) of 10:90 to 40:60, and which is obtained by polymerization of the monomers for the rubber copolymer (A1c) in the presence of the innermost layer polymer (A1a); and
the innermost layer polymer (A1a) is a polymer of 100% by weight of monomers for innermost layer polymer (A1a) containing 40 to 99.9% by weight of one or more monomers selected from the group consisting of alkyl methacrylates and aromatic vinyl compounds, 59.9 to 0% by weight of another copolymerizable vinyl monomer, and 0.1 to 5% by weight of a polyfunctional monomer.

11. The resin composition according to claim 8,
wherein the rubber-containing acrylic graft copolymer (A1) has a number average particle diameter of 30 to 400 nm.

12. A resin molded product which is obtained by molding the resin composition according to claim 1.

13. The resin molded product according to claim 12 which has jet-blackness.

14. An automobile component produced from the resin molded product according to claim 12.

15. The resin molded product according to claim 12,
wherein the molded product formed into a plate shape by injection molding with a mirror-polished mold has an L value of 0 to 8, the L value being measured with a 0° to 45° spectroscopic color difference meter in conformity with JIS Z 8722.

16. The resin molded product according to claim 15,
wherein the difference of L values of the molded product before and after a weather resistance test measured with a color difference meter is between 0 and 1,
the molded product being formed into a plate shape by injection molding with a mirror-polished mold, and
the test being in conformity with JIS K 7350-4 and performed for 1,000 hours under the following conditions: black panel 63° C., with rain, and 255 W/m².
